(19) United States
(12) Patent Application Publication
(10) Pub. No.: US 2014/0069001 A1
(43) Pub. Date: Mar. 13, 2014

(54) PLANTING MIX COMPOSITIONS AND METHODS

(71) Applicant: Rose Agri-Seed, Inc., Canby, OR (US)

(72) Inventor: Bill L. Rose, Hubbard, OR (US)

(73) Assignee: Rose Agri-Seed, Inc., Canby, OR (US)

(21) Appl. No.: 14/075,458

(22) Filed: Nov. 8, 2013

Related U.S. Application Data
(63) Continuation-in-part of application No. 13/765,655, filed on Feb. 12, 2013.
Application No. 13/765,655 is a continuation-in-part of application No. 13/544,894, filed on Jul. 9, 2012.
Application No. 13/544,894 is a continuation-in-part of application No. 13/211,202, filed on Aug. 16, 2011, now abandoned.
Application No. 13/211,202 is a continuation-in-part of application No. 13/544,894, filed on Jul. 9, 2012.
Application No. 13/544,894 is a continuation-in-part of application No. 12/056,156, filed on Mar. 26, 2008, now abandoned.
(60) Provisional application No. 61/374,164, filed on Aug. 16, 2010.
(60) Provisional application No. 60/920,352, filed on Mar. 26, 2007.

(51) Int. Cl. A01C 1/06

(52) U.S. Cl. CPC A01C 1/06
USPC 47/57.6; 264/141

(57) ABSTRACT

This application provides planting mix compositions that include pelletized coir. Seed, cornmeal or corn flour, fungicide, and optionally activated charcoal, compost, and/or a super-absorbent polymer (SAP) can be included in the planting mix compositions. Methods of making such compositions are also disclosed herein. In particular examples, such compositions include pelletized coir at least partially coated with a binder, seeds, charcoal, and optionally a SAP. In other examples, such compositions include a pelletized mixture that includes coir, cornmeal or corn flour, charcoal, a SAP, compost, a fungicide, and seeds, wherein the seeds are encased within the pellets.

### CROSS-REFERENCE TO RELATED APPLICATION

This is a continuation-in-part of co-pending U.S. application Ser. No. 13/765,655, filed Feb. 12, 2013, which is a continuation-in-part of co-pending U.S. application Ser. No. 13/544,894, filed Jul. 9, 2012, which is a continuation-in-part of U.S. application Ser. No. 13/211,202, filed Aug. 16, 2011, which claims the benefit of U.S. Application No. 61/374,164, filed Aug. 16, 2010. This is a continuation in part of co-pending U.S. application Ser. No. 13/544,894, filed Jul. 9, 2012, which is a continuation-in-part of U.S. application Ser. No. 12/056,156, filed Mar. 26, 2008, now abandoned, which claims the benefit of U.S. Application No. 60/920,352, filed Mar. 26, 2007. All of the above applications are herein incorporated by reference.

### FIELD

This application relates to planting mix compositions that prepare seed for planting and methods of preparing such compositions. Such compositions include pelletized and/or ground coir. Seed, corn flour, and optionally a super-absorbent polymer (SAP), compost, and/or charcoal, can be included in the planting mix compositions.

### BACKGROUND

Several benefits of treating planting seed have been reported. For example, seeds can be coated to protect and enhance the environment surrounding the natural seed coat. Coating a seed can increase seed germination, improve seedling growth rate, and provide protection during dry spells until growth is established. When planting small seeds, such as bentgrass, at low planting rates, increasing the bulk greatly facilitates accurate seed placement. Seed coatings have been used as carriers for a variety of components, such as agrochemicals, nutrients, and plant growth regulators. In addition, seeds can be treated to reduce incidences of stand loss due to diseases and insects.

The germination of a coated seed is dependent on the seed absorbing moisture after sowing and cracking the coating to allow light and moisture. If the coated layer is not cracked, or it is cracked only with a small width and the seed is not exposed to a satisfactory amount of light, germination will be inhibited. Germination of seeds, either coated or uncoated, and the establishment of seedlings that have sprouted from such seeds, are also dependent upon the growing medium in which the seed is mixed. Therefore, compositions are needed that can, in some examples, increase moisture and/or nutrients available to a seed.

### SUMMARY

Seeds are routinely coated to improve seed ‘plant-ability’ and to incorporate seed treatment chemicals and nutrients so they are immediately available to the young seedlings. Maintaining optimum moisture levels can increase the germination and/or establishment of seed. The inventor has found that mixing seeds with ground and/or pelletized coir, and in some examples further including a super-absorbent polymer (SAP) and/or corn flour, provides an unexpectedly superior environment for germination and/or establishment. For example, the germination of the seeds can be increased, such as evidenced by one or more of increased germination rate, earlier seed germination, increased crop growth, or increased crop production. In other examples, establishment can be increased, such as evidenced by one or more of increased rate of establishment, earlier establishment, increased seed crop growth, or increased seed crop production. In addition, such planting mixes can be spread with commercially available spreaders, such as those from Scotts.

Provided herein are compositions, such as planting mixes, that include coir. Particular examples of the planting mixes that include coir also include charcoal, a super-absorbent polymer (SAP), fertilizers, pesticides, fungicides, growth hormones, soil-based nutrients, compost, nitrogen, potassium, phosphorous, colorants, corn flour, inoculate of beneficial bacteria, mycorhizzae, or combinations thereof. In some embodiments, the compositions including coir are pelletized.

In particular embodiments of the pelletized coir, seed is included in the pellet. For example, seed is mixed with the planting mix components and is embedded or encased in the pellet during formation of the pellet. In specific examples of the planting mix, cornmeal or corn flour and charcoal are included with the coir and seed in the mixture that forms the pellet. In further embodiments, a SAP, compost, charcoal, and/or a fungicide are included in the mixture that forms the pellet.

In other embodiments, the seed is attached to the surface of the pellet after formation of the pellet. In particular examples, the pelletized coir is at least partially coated with seeds and optionally charcoal, which are adhered to the pelletized coir by a binder. In some examples the pelletized coir can further include a SAP adhered to the pelletized coir by a binder. In some examples, the seeds on the coir surface are at least partially coated with a SAP, such as a starch-based SAP. In one example the binder is an at least partially water-soluble binder, such as polyvinyl alcohol (PVOH) or lignosulfanate. In some examples, the composition further includes compost. In particular examples, the pelletized coir does not have cavities greater in diameter than the diameter of the seed, for example cavities generated by a machine for the purpose of creating a cavity that can hold the seed, which can then be covered.

In further embodiments, the compositions include ground coir or ground pelletized coir. In particular embodiments, the compositions include ground coir or ground pelletized coir, combined with pelletized coir. Yet other embodiments include seeds, for example wherein the seeds are not attached to the pelletized coir but are mixed with the pelletized coir. Such a composition can include other components, such as a SAP, charcoal, fertilizers, pesticides (such as a fungicide), growth hormones, soil-based nutrients, compost, nitrogen, potassium, phosphorous, colorants, inoculate of beneficial bacteria, mycorhizzae, or combinations thereof.

Any seed can be used in the compositions disclosed herein, such as grass seeds, flower seeds (such as wildflower seeds), vegetable seeds, or other crop seed. In particular examples, when compared to normal raw seed plantings, the disclosed compositions are at least 200%, at least 300%, at least 400%, such as 300-400%, more successful (e.g., increased germination and/or earlier establishment). The disclosed compositions can be packaged, for example placed into planting mix bags, seed bags, and the like.

Also provided are methods of making a planting mix. In particular examples, the methods include mixing the planting mix components, including the seed, coir, charcoal, compost, fungicide, SAP, and/or corn flour, to form a dough including seeds. The method can further include passing the dough including the seeds through an extruder, cutting the extruded dough into pellets, and allowing the pellets to dry, forming seed-encased dough pellets.

In other examples the methods include adhering seed and charcoal to pelletized coir using a binder (such as a water-soluble binder), thereby generating a planting mix. The method can further include adhering SAP to pelletized coir using a binder. In some examples, seed to be adhered to the pelletized coir is at least partially coated with a SAP (and in some examples also with a binder). The method can further include generating the pelletized coir, for example by grinding blocks of coir to achieve at least 10 lb/bushel density (such as at least 20 lb/bushel density, at least 30 lb/bushel density, for example 12-20 lb/bushel density or 20-45 lb/bushel density), thereby generating ground coir; and milling the ground coir (for example in a California pellet mill) to densify the ground coir, for example to achieve at least 40 lb/bushel density (such as at least 45 lb/bushel density, at least 50 lb/bushel density, for example 40 to 80 lb/bushel density or 40 to 60 lb/bushel density), thereby generating pelletized coir. In some examples, coir is ground with a tub grinder, then pelletized, then reground to achieve 45/60 lbs bushels. 7/16″ square cubes are about 32 lb/bushels and ½″ square cubes are about 30 lb/bushels

In particular examples, the method does not include compressing the seeds with the coir under conditions of high temperature (which may kill the seeds); instead the coir is compressed and the seeds subsequently adhered to the pelletized coir. In some examples, the method generates dough pellets that are at least at least 20 lb/bushel density (such as at least 30 lb/bushel density, at least 40 lb/bushel density, for example 20-45 lb/bushel density or 30-40 lb/bushel density). In further examples, the method generates dough pellets that are at least 21 lb/bushel density, at least 22 lb/bushel density, at least 23 lb/bushel density, at least 24 lb/bushel density, at least 25 lb/bushel density, at least 26 lb/bushel density, at least 27 lb/bushel density, at least 28 lb/bushel density, at least 29 lb/bushel density, at least 30 lb/bushel density, at least 31 lb/bushel density, at least 32 lb/bushel density, at least 33 lb/bushel density, at least 34 lb/bushel density, at least 35 lb/bushel density, at least 36 lb/bushel density, at least 37 lb/bushel density, or more.

In particular examples, the method does not include introducing cavities into the coir, for example using a machine to introduce cavities or wells about the size of the seed, into which seed can be added, and the cavity closed or sealed. In particular examples, the method further includes planting the coated seed-coated bulking agent mixture, thereby improving germination of the seed in the mixture. In other particular examples of the methods, pelletized coir is ground and other planting mix components, such as seeds, are added to the ground coir. In one specific, non-limiting example, the pelletized coir is ground and then mixed with pelletized coir which may or may not contain seeds on its surface.

The disclosed compositions, such as the disclosed seed-containing pellets (for example, seed-coated pellets or seed-encased pellets) can be used under drought conditions on range lands or considerable rocky soils. In one example, the disclosed seed-containing pellets are square in shape, such as 7/16″ or ½″ cubes. In one example, the disclosed seed-containing pellets contain SAP for moisture retention, and provide an environment that enables establishment and suitable stands of grass in water-poor areas, which would be impossible by currently known methods. The disclosed seed-containing pellets can also be used in environments having short growing seasons due to delayed snow melt and/or cool temperatures. For example, the seed-containing pellets can be applied to snow-covered fields so that, once the snow melts, the seeds are already in place to begin germination. The disclosed seed-containing pellets can also be used (for example dropped or spread) in environments recently denuded by fire, for example, in forests or grasslands, to assist in re-growth of desired plants, for example native grasses, in order to prevent erosion, regenerate a grass cover, and stop weeds from establishing which can lead to repetitive fires in the same location.

In some examples, for example when the composition includes ground coir and seeds, the composition can be evenly spread on a surface (such as an area needing re-seeding) using a seed spreader, such as those available to the public for spreading lawn fertilizer and grass seed. In one example, a composition comprising or consisting of 9 lbs of processed coir: 1 lb of seed (such as grass seed) is used to spread a lawn, or spread on a lawn, for example as a patch.

The foregoing and other objects and features of the disclosure will become more apparent from the following detailed description, which proceeds with reference to the accompanying figures.

### BRIEF DESCRIPTION OF THE DRAWINGS

FIG. 1 is a digital image of a germinated planting mix containing ryegrass seeds adhered to pelletized coir 14 days after planting.

FIG. 2 is a digital image of a germinated planting mix containing perennial ryegrass seeds adhered to pelletized coir. The seed-coated coir was planted on April 15 by dropping the seed-coated coir into snow in Alberta Canada. The image was obtained on July 22.

FIG. 3 is a digital image of a germinated planting mix containing perennial ryegrass seeds adhered to pelletized coir. The seed-coated coir was planted on May 8 by placing the seed-coated coir on the surface of dry soil (the soil was dry for at least 1 inch below the pellet surface) in Alberta Canada. The image was obtained on July 22.

FIG. 4 is a digital image of a partially unrolled moistened paper towel containing canola seed-encased dough pellets at day 6, wherein the seeds have germinated.

FIG. 5 is a digital image of an unrolled moistened paper towel containing canola seed-encased dough pellets at day 6, wherein the seeds have germinated. Green horizontal markings on the paper towel are at 1 inch intervals.

FIG. 6 is a digital image showing an unrolled moistened paper towel containing canola seed-encased dough pellets at day 6, wherein the seeds have germinated. The root length of an exemplary germinated seed is shown using a ruler. Green horizontal markings on the paper towel are at 1 inch intervals.

FIG. 7 is a bar graph showing the ability of several different grass-patch products to green up a lawn (% green). The superior product, RSE Pellet SH, is 90% coir, 10% seed.

### DETAILED DESCRIPTION

The following explanations of terms and methods are provided to better describe the present disclosure and to guide those of ordinary skill in the art in the practice of the present disclosure. The singular forms “a,” “an,” and “the” refer to one or more than one, unless the context clearly dictates otherwise. For example, the term “comprising a seed” includes single or plural seeds and encompasses the phrase “comprising at least one seed.” The term “or” refers to a single element of stated alternative elements or a combination of two or more elements, unless the context clearly indicates otherwise. As used herein, “comprises” means “includes.” Thus, “comprising A or B,” means “including A, B, or A and B,” without excluding additional elements.

Unless explained otherwise, all technical and scientific terms used herein have the same meaning as commonly understood by one of ordinary skill in the art to which this disclosure belongs.

Binder:

A material used to adhere one agent to another, for example adhere SAP to seed or seed to pelletized coir. In particular examples, a binder provides a moist environment thereby allowing attachment of another agent, such as SAP or charcoal to seed; or seed, charcoal, or SAP to pelletized coir. A particular non-limiting example of a binder is an at least partially water soluble binder, such as polyvinyl alcohol (PVOH) or lignosulfanate.

Coir:

The coarse fiber found between the husk and the outer shell of a coconut. Coir can be used as a bulking agent to absorb moisture. For example, seed can be attached to the outer surface of coir that has been pelletized or embedded/encased within pelletized coir, for example to improve the physical handling properties of the seed, for example water retention, flowability, water infiltration, drainage, aeration and structure. In some examples, coir is in a ground, crushed, object, particle or granular form. Ground coir can be fine, medium, or coarse. In one embodiment, fine coir is ground coir that passes through a 40×40 wire mesh screen. In another embodiment, the remaining medium and coarse coir are separated by passing the medium grade coir through a 1/12 round hole screen and the coarse grade coir is retained by a 12/64 round hole screen. Pelletized coir refers to coir that is ground and formed into pellets (pelletized), such as pellets having a size of about 5 mm diameter, for example about 5 mm length×5 mm diameter or 5 mm diameter×10 mm length. In other embodiments, the pelletized coir is about ⅜ inch diameter×½ inch length or about ¼ inch diameter×½ inch length. In particular embodiments, pelletized coir is ground, for example ground and screened to about the same size as the seeds to be used with the ground coir. Pelletized and ground coir can be mixed, for example in equal proportions. In some embodiments, pelletized and ground coir are mixed with other planting mix components.

Coating:

To apply a material to the outer surface of an agent. In particular examples, includes applying a material to the outer surface of a coir pellet or the outer surface of seed. However, coating does not require 100% coverage of the surface of the agent; partial coverage can be sufficient. For example, coating can in some examples result in coverage of at least 1% of the surface by the material, such as at least 10%, at least 20%, at least 50%, at least 80%, at least 95%, or at least 99% coverage of the surface of the desired (such as a coir pellet or seed surface).

A coating material can be directly applied to the agent (for example by incubating the coating material with the agent to be coated), or indirectly applied (for example by adhering a first material to the surface of the agent to be coated that permits attachment of a second material, and then adhering the second material to the agent already coated with the first material).

In one particular example, coating does not result in significant or any penetration of the covering or coating into the agent, such as penetration of a seed or coir pellet. In some examples, the thickness of a coating applied is at least 0.01 mm, for example at least 0.05 mm, such as about 0.01 mm to 0.1 mm. In particular examples, coating an agent alters the properties of the agent, for example to increase the ability of the agent to retain or absorb moisture.

Compost:

Organic matter, such as plant material and some food waste, that has been decomposed into humus after a period of weeks, months or years (such as 1-2 years), and recycled as a fertilizer and soil amendment.

Establishment:

A germinated seed, seedling, or plant that survives after planting. An established germinated seed, seedling, or plant will have one or more of a cotyledon, a hypocotyl, an epicotyl, leaves, flowers, a primary root, or secondary roots. An established germinated seed or seedling can mature into a plant, for example a plant that produces a crop, such as grass seed, cotton seed, soybean, rapeseed, canola seed, or wheat crop. Seedling vigor and/or the number of seedlings growing over time, compared to the total number of planted seedlings (or plant vigor and/or the number of plants growing over time, compared to the total number of planted plants) is an exemplary measure of establishment. A rate of establishment is the number of established seedlings or plants sprouted from seed over time, compared to the total number of seeds.

Fertilizer:

Any organic or inorganic material of natural or synthetic origin that is added to a soil to supply one or more plant nutrients essential to the growth of plants. Fertilizers typically provide, in varying proportions, six macronutrients (nitrogen (N), phosphorus (P), potassium (K), calcium (Ca), magnesium (Mg), and sulfur (S)) and eight micronutrients (boron (B), chlorine (Cl), copper (Cu), iron (Fe), manganese (Mn), molybdenum (Mo), zinc (Zn), and nickel (Ni)). Fertilizers are labeled using numbers representing the analysis of specific macronutrients. Typically, three numbers on the fertilizer label represent an analysis of the composition by percentage weight. These three numbers correspond to nitrogen, phosphorus, and potassium (N—P—K) and always appear in that specific order. When a fourth number is included, it indicates the sulfur content (N—P—K—S).

Germination:

The sprouting of a seed that yields a seedling or plant. Germination is evidenced by the appearance of the radicle, the primary root, the hypocotyl, the cotyledon, or a combination thereof. Seed germination rate is the number of seeds germinating over time, compared to the total number of seeds.

Germination Rate:

The proportion of seeds in a given batch or lot of seed that germinate. For example, a germination rate of 50% indicates that about 50% of the seeds in the batch will germinate when planted under conditions that permit germination.

Seed:

The ripened ovule of gymnosperm or angiosperm plants, and includes the embryo and its proper coats and can also include the seed coat (an outer protective covering). Seeds are very diverse in size and shape. The disclosure is not limited to particular plant seeds, and can include for example grass seeds (such as a perennial ryegrass, fescue (such as tall fescue or hard fescue, for example Soil Guard hard fescue, Cowgirl tall fescue), bentgrass, Bermuda grass, smooth brome grass, seashore paspalum, or a switchgrass), flower seeds (such as wild flower seeds), tree seeds, vegetable seeds (such as tomato, lettuce, or cucumber seeds) or other crops (such as cotton seeds, soybeans, rapeseeds, canola seeds, and wheat). In a specific example, the seed is a grass seed.

Super-Absorbent Polymer (SAP):

Materials that imbibe or absorb large quantities of aqueous fluid (such as water), for example at least 10 times their own weight, and that retain the imbibed or absorb aqueous fluid under moderate pressure. Generally, SAPs are water-insoluble polymers which swell or gel in aqueous fluids but do not dissolve in the fluids. Some SAPs can absorb 600 to 1000 times their weight in aqueous fluid. These polymers are typically lightly cross-linked polymers, which contain a multiplicity of acid functional groups such as carboxylic acid and carboxamide acid groups.

Exemplary SAPs include totally synthetic copolymers (such as those made by copolymerizing acrylic acid and acrylamaide in the presence of a coupling agent), starch graft copolymers (such as those that use a natural polymer, such as starch to form an SAP product including a starch graft copolymer), and starch-based SAPs (such as those described in US Patent Application No. 2005/0159315, herein incorporated by reference as to the composition of the starch-based SAP, for example Zeba®).

In one example the SAP does not include starch. For examples the SAP can include or consist of acrylamide and/or potassium acrylate (such as Tramfloc® products, such as Tramfloc® 1001, 1002, 1009, 1153, 1158 or 1159).

### Plant Seed Compositions

The present disclosure provides planting mix compositions. In some embodiments, such compositions include pelletized coir, ground coir (such as ground pelletized coir), or both. In particular examples, such compositions include pelletized coir that has seed (such as naked seed or seed at least partially coated with a SAP, such as Zeba®, and/or charcoal) and activated charcoal attached to the pelletized coir, for example attached thereto with polyvinyl alcohol (PVOH) or another binder or glue that does not substantially inhibit seed germination and aids in the establishment of plants in dry conditions. The attachment of a seed to an organic material such as coir permits the seed-coated coir to hold moisture which is made available to the seed during germination, for example in climates that are dry. In other particular examples, such compositions include seed, but it is mixed with the pelletized coir and not attached to the pelletized coir. In further embodiments, such compositions include pelletized coir that has seed embedded or encased within the pellet. In specific, non-limiting embodiments, the composition, prior to pelletizing, includes coir, seeds, and charcoal. In other specific non-limiting embodiments, the composition prior to pelletizing includes coir, seeds, charcoal, pesticide (such as fungicide), fertilizer (for example, a 14-14-14 fertilizer), inoculate of beneficial bacteria, mycorhizzae (specialized fungi that colonize plant roots, and by extending far into the soil are more effective in nutrient and water absorption than the plant's roots), or combinations thereof.

In other embodiments, the planting mix composition is formed into a dough that includes corn flour (such as that used in tortillas) and naked seed to form a seed-containing dough, which can be passed through an extruder to produce strands of seed-encased dough, then cut into pellets (seed-encased dough pellets) and dried. Passing the disclosed seed-containing dough through the extruder to form pellets does not damage the seeds. This is in contrast to pellets formed by compression, for example in a California pellet mill, which process generates high heat and damages the seeds. To avoid damage to the seed during the compression process, seeds are attached to the surface of the pelletized coir, as discussed in more detail below. Thus, an advantage of the extruded dough pellets (with seed encased in the pellets) over the compressed coir pellets (with seed attached to the surface of the pellets), is that the seed is not exposed to high heat during production of the dough pellet, the durable dough pellet protects the seed, and there is less loss of seed from the dough pellet, for example due to seed falling off the surface of the pellet, for example during transportation.

In some examples, the disclosed planting mix compositions further include other planting mix components (agents), such as compost, a SAP, charcoal, fertilizers, pesticides (such as a fungicide), growth hormones, soil-based nutrients, nitrogen, potassium, phosphorous, colorants, inoculate of beneficial bacteria, mycorhizzae, or combinations thereof, resulting in an organic garden composition with excellent germination. In some embodiments of the planting mix, coir is ground. In particular embodiments, ground coir is formed into pellets. In further embodiments, pelletized coir is ground. In further embodiments, ground coir is mixed with seed and can include other components, such as a SAP, charcoal, fertilizers, pesticides (such as a fungicide), growth hormones, soil-based nutrients, compost, nitrogen, potassium, phosphorous, colorants, inoculate of beneficial bacteria, mycorhizzae, or combinations thereof. In yet other embodiments, ground coir is mixed with pelletized coir (which may or may not contain seed) and seed, and can include other components, such as a SAP, charcoal, fertilizers, pesticides (such as a fungicide), growth hormones, soil-based nutrients, compost, nitrogen, potassium, phosphorous, colorants, inoculate of beneficial bacteria, mycorhizzae, or combinations thereof.

Blocks of coir can be processed into smaller particles or granules or irregular pieces. For example, the coir can be ground or otherwise fragmented. For example, coir can be mechanically ground into smaller particles using methods known in the art, such as using a hammermill or tub grinder. In particular examples, the coir is ground to a desired size. For example, the coir can be ground to fine, medium, or course grade. In some examples, the ground coir is passed through a screen of a certain pore size and only ground coir particles that pass through the screen are of the desired size.

Ground coir that is larger than the screen pore size (i.e., larger than the desired size) can be reground, for example until the ground coir reaches the desired size. In some embodiments, the desired size of the ground coir particles is the size of the seed with which the ground coir will be mixed. Generally, the grind size of the coir ranges from being able to pass through an approximately ⅛ inch mesh screen to being able to pass through an approximately ½ inch mesh screen. Specific, non-limiting examples of a desired size of ground coir particles include particles that pass through or are retained by a screen with holes between 4/64 and 10/64, for example 7/64. In other specific, non-limiting examples, the desired size of ground coir particles (for example, fine, medium, or coarse grade coir) include particles that pass through or are retained by a 20×20, 30×30, 40×40, 50×50, or 60×60 wire mesh screen, or a 1/16, 1/15, 1/14, 1/13, 1/12, 6/64, or 7/64 round hole screen. In yet another specific, non-limiting example, the desired size of ground coir particles include particles that are retained by or pass through a screen with holes between 10/64 and 14/64, for example, a 11/64, 12/64, or 13/64 round hole screen. In some examples, coir is ground under conditions that result in a density of coir that is at least 30 lb/bushel, at least 32 lb/bushel, at least 40 lb/bushel, at least 50 lb/bushel, at least 60 lb/bushel, such as 30-35 lb/bushel, 30-40 lb/bushel, 40 to 60 lb/bushel, or 45-50 lb/bushel.

Various percentages of ground coir can be included in a planting mix composition, for example, in the planting mix used to make pellets (such as dough or coir pellets). In some examples, the coir is about 10%-60%, about 20%-50%, about 30%-40%, about 40%-50%, about 40%-60%, about 20-40%, about 30%-40%, about 10-90%, or about 30%-50% weight/weight (w/w) or more of the planting mix composition. In other examples, the coir is at least 10%, at least 15%, at least 20%, at least 25%, at least 30%, at least 33%, at least 35%, at least 40%, at least 45%, at least 50%, at least 55%, at least 60%, at least 80%, at least 90%, or at least 95% (w/w) or more of the planting mix composition. In particular examples, the coir is at least 11%, at least 12%, at least 13%, at least 14%, at least 15%, at least 16%, at least 17%, at least 18%, at least 19%, at least 20%, at least 21%, at least 22%, at least 23%, at least 24%, at least 25%, at least 26%, at least 27%, at least 28%, at least 29%, at least 30%, at least 31%, at least 32%, at least 33%, at least 34%, at least 35%, at least 36%, at least 37%, at least 38%, at least 39%, at least 40%, at least 41%, at least 42%, at least 43%, at least 44%, at least 45%, at least 46%, at least 47%, at least 48%, at least 49%, at least 50%, at least 51%, at least 52%, at least 53%, at least 54%, at least 55%, at least 56%, at least 57%, at least 58%, at least 59%, at least 60%, at least 80%, at least 90%, or at least 95% (w/w) or more of the planting mix composition. The ground coir included in the pellets can be fine, medium, or coarse grade ground coir, or a combination thereof.

A SAP (for example, a starch-based SAP, such as Zeba®) can be included in the disclosed planting mix composition, for example, in the planting mix used to make dough pellets or coir pellets. SAPs are agents that can absorb aqueous fluids and retain the fluid under moderate pressure, such as water-insoluble hydrogel-forming polymers which swell aqueous fluids but do not dissolve in the fluids. SAPs are known in the art, and the disclosure is not limited to particular SAPs. Examples of SAPs that can be used include but are not limited to cross-linked polyacrylamide polymers (such as Broadleaf P4, SANWET IM-300 and IM-1000, AQUASTORE, AGRIGEL, and GROWSOAK 400, seaweed based products (such as ALGINURE), starch graft copolymers, and starch-based SAPs. In a specific example, the SAP is a starch-based SAP, such as those described in US Application No. 2005/0159315 (herein incorporated by reference as to the starch-based SAP compositions), for example Zeba® (Absorbent Technologies, Inc., Oregon).

The concentration of SAP to be used can be determined by those skilled in the art. In some examples, the SAP is about 1%-6%, about 2%-5%, about 3%-4%, about 4%-5%, about 4%-6%, about 2-4%, about 1-2%, about 1-3%, or about 3%-5% w/w or more of the planting mix composition. In some examples, the SAP is less than 1% (w/w) of the planting mix composition. In other examples, the SAP is at least 1%, at least 1.5%, at least 2%, at least 2.5%, at least 3%, at least 3.5%, at least 4%, at least 5%, at least 7.5%, at least 10% (w/w), or more of the planting composition.

In other embodiments, activated charcoal is included in the disclosed planting mix composition, for example, in the planting mix used to make dough pellets or coir pellets. Charcoal imparts herbicide resistance to the seed in the planting mix compositions disclosed herein. In some embodiments, the charcoal, which is black, absorbs heat and helps to create an environment for the seed that is conducive to germination, particularly in environments having short growing seasons due to delayed snow melt and/or cool temperatures. In some examples, the charcoal is about 1%-15%, about 1%-10%, about 1%-5%, about 5%-15%, about 10%-15%, about 2%-5%, about 3%-4%, about 4%-5%, about 4%-6%, about 2-4%, about 1-2%, about 1-3%, or about 3%-5% w/w or more of the planting mix composition. In some examples, the charcoal is less than 1% (w/w) of the planting mix composition. In other examples, the charcoal is at least 1%, at least 1.5%, at least 2%, at least 2.5%, at least 3%, at least 3.5%, at least 4%, at least 5%, at least 7.5%, at least 10% (w/w), or more of the planting composition. In yet other example, a 300 lb charcoal per acre rate is achieved. Charcoal in the planting mix composition, for example in the pelletized coir, absorbs heat from the sun and helps to create an environment for the seed that is conducive to germination. In addition, charcoal provides herbicide protection to the seeds from chemicals, such as Diuron, which may be applied to the environment before the seeds are planted or before the seeds germinate. In some embodiments, charcoal is not included if the seed included in the planting mix has herbicide resistance.

Fungicides can be included in the planting mix composition, for example, in the planting mix used to make dough pellets or coir pellets. In some examples, the fungicide is about 1%-6%, about 2%-5%, about 3%-4%, about 4%-5%, about 4%-6%, about 2%-3%, about 2%-4%, about 1%-2%, about 1%-3%, or about 3%-5% w/w or more of the planting mix composition. In some examples, the fungicide is less than 1% (w/w) of the planting mix composition. In other examples, the fungicide is at least 1%, at least 1.5%, at least 2%, at least 2.5%, at least 3%, at least 3.5%, at least 4%, at least 5%, at least 7.5%, at least 10% (w/w), or more of the planting composition. Examples of fungicides include Captan and ApronXL®.

Pesticides also can be included in the planting mix composition, for example, in the planting mix used to make dough pellets or coir pellets. In some examples, the pesticide is about 1%-6%, about 2%-5%, about 3%-4%, about 4%-5%, about 4%-6%, about 2%-3%, about 2%-4%, about 1%-2%, about 1%-3%, or about 3%-5% w/w or more of the planting mix composition. In some examples, the pesticide is less than 1% (w/w) of the planting mix composition. In other examples, the pesticide is at least 1%, at least 1.5%, at least 2%, at least 2.5%, at least 3%, at least 3.5%, at least 4%, at least 5%, at least 7.5%, at least 10% (w/w), or more of the planting composition. One specific, non-limiting example of a pesticide is Lorsban®.

Cornmeal or corn flour can also be a component of the disclosed planting mix composition, for example, in the planting mix composition used to make dough pellets. For example, the planting mix can include about 10%-60%, about 20%-50%, about 30%-40%, about 40%-50%, about 40%-60%, about 20-40%, or about 30%-40%, about 30%-60% (w/w), or about 40-45% (such as 42, 42.5, or 43%) or more cornmeal or corn flour in the planting mix composition. In other examples, the cornmeal or corn flour is at least 10%, at least 11%, at least 12%, at least 13%, at least 14%, at least 15%, at least 16%, at least 17%, at least 18%, at least 19%, at least 20%, at least 21%, at least 22%, at least 23%, at least 24%, at least 25%, at least 26%, at least 27%, at least 28%, at least 29%, at least 30%, at least 31%, at least 32%, at least 33%, at least 34%, at least 35%, at least 36%, at least 37%, at least 38%, at least 39%, at least 40%, at least 41%, at least 42%, at least 43%, at least 44%, at least 45%, at least 46%, at least 47%, at least 48%, at least 49%, at least 50%, at least 51%, at least 52%, at least 53%, at least 54%, at least 55%, at least 56%, at least 57%, at least 58%, at least 59%, at least 60% (w/w) or more of the planting mix composition.

In some embodiments, lime is a component of the planting mix, for example, in the planting mix used to make dough pellets or coir pellets. For example, the planting mix can include about 1-10%, about 2-8%, about 4%-6%, or about 5%, (w/w) of lime in the planting mix composition. In some examples, lime is added to equal 1500 lbs per acre rate on 1 square inch of soil.

In some embodiments, compost is a component of the planting mix, for example, in the planting mix used to make dough pellets or coir pellets. For example, the planting mix can include about 5-20%, about 5-10%, about 10%-60%, about 20%-50%, about 30%-40%, about 40%-50%, about 40%-60%, about 20-40%, or about 30%-40%, about 30%-60% (w/w), or more compost in the planting mix composition. In other examples, the compost is at least 10%, at least 11%, at least 12%, at least 13%, at least 14%, at least 15%, at least 16%, at least 17%, at least 18%, at least 19%, at least 20%, at least 21%, at least 22%, at least 23%, at least 24%, at least 25%, at least 26%, at least 27%, at least 28%, at least 29%, at least 30%, at least 31%, at least 32%, at least 33%, at least 34%, at least 35%, at least 36%, at least 37%, at least 38%, at least 39%, at least 40%, at least 41%, at least 42%, at least 43%, at least 44%, at least 45%, at least 46%, at least 47%, at least 48%, at least 49%, at least 50%, at least 51%, at least 52%, at least 53%, at least 54%, at least 55%, at least 56%, at least 57%, at least 58%, at least 59%, at least 60% (w/w) or more of the planting mix composition.

In some embodiments, the compost contains nitrogen, phosphorus, phosphate (P₂O₅), potassium, potash (K₂O), or a combination thereof. In one embodiment, the compost is one that includes at least 1% nitrogen, for example at least 1.1%, at least 1.2%, at least 1.3%, at least 1.4%, at least 1.5%, at least 1.6%, at least 1.7%, at least 1.8%, or at least 1.9% nitrogen. In other embodiments, the compost includes at least 1.41%, at least 1.42%, at least 1.43%, at least 1.44%, at least 1.45%, at least 1.46%, at least 1.47%, at least 1.48%, or at least 1.49% nitrogen. In other embodiments, the compost includes at least 0.1%, at least 0.2%, at least 0.3%, at least 0.4%, at least 0.5%, at least 0.6%, at least 0.7%, at least 0.8%, at least 0.9% phosphorus. In other embodiments, the compost is one that includes at least 0.31%, at least 0.32%, at least 0.33%, at least 0.34%, at least 0.35%, at least 0.36%, at least 0.37%, at least 0.38%, or at least 0.39% phosphorus. In yet other embodiments, the compost includes at least 0.5%, at least 0.6%, at least 0.7%, at least 0.8%, at least 0.9%, at least 1.0%, at least 1.1%, or at least 0.2% phosphate. In other embodiments, the compost is one that includes at least 0.81%, at least 0.82%, at least 0.83%, at least 0.84%, at least 0.85%, at least 0.86%, at least 0.87%, at least 0.88%, or at least 0.89% phosphate. In further embodiments, the compost includes at least 1.01%, at least 1.02%, at least 1.03%, at least 1.04%, %, at least 1.05%, at least 1.06%, at least 1.07%, at least 1.08%, at least 1.09%, at least 1.10%, at least 1.11%, at least 1.12% potassium. In other embodiments, the compost is one that includes at least 1.085%, at least 1.086%, at least 1.087%, at least 1.088%, at least 1.089%, at least 1.091%, at least 1.092%, or at least 1.093% potassium. In some embodiments, the compost includes at least 1.1%, at least 1.2%, at least 1.3%, at least 1.4%, %, at least 1.5%, at least 1.6%, at least 1.7%, at least 1.8%, at least 1.9%, at least 2.0% potash. In other embodiments, the compost is one that includes at least 1.290%, at least 1.310%, at least 1.320%, at least 1.330%, at least 1.340%, or at least 1.310% potash. In yet other embodiments, the compost is one that includes at least 1.311%, at least 1.312%, at least 1.313%, at least 1.314%, at least 1.315%, at least 1.316% potash. In one specific, non-limiting example, the compost includes at least 1.43% nitrogen, at least 0.37% phosphorus, at least 0.85% phosphate, at least 1.090% potassium, and at least 1.313% potash.

In some embodiments, seed is included in the planting mix composition, for example, in the planting mix used to make dough pellets or coir pellets. In some examples, the seed is about 1%-20%, about 1%-15%, about 1%-10%, about 1%-6%, about 2%-5%, about 3%-4%, about 4%-5%, about 4%-6%, about 2%-3%, about 2%-4%, about 1%-2%, about 1%-3%, or about 3%-5% w/w or more of the planting mix composition. In some examples, the seed is less than 1% (w/w) of the planting mix composition. In other examples, the seed is at least 1%, at least 1.5%, at least 2%, at least 2.5%, at least 3%, at least 3.5%, at least 4%, at least 5%, at least 7.5%, at least 10%, at least 15%, at least 20% (w/w), or more of the planting composition. In some examples of pellets, the number of seeds per pellet is 1, 2, 3, 4, 5, 6, 7, 8, 9, or 10 seeds per pellet, such as 3 seeds per pellet to 5 seeds per pellet, or 1 to 5 seeds per pellet, or 1 to 10 seeds per pellet.

The disclosure is not limited to use of particular seeds. Seeds from any plant can be used, such as grass seeds, flower seeds (such as wildflower seeds), vegetable seeds, or other crop seed (such as canola, wheat, rapeseed, corn and the like). In addition, the seed can include a mixture of different types of seeds, such as a mixture of different grass seeds, different wildflower seeds, different legumes, different crop seeds, or any combination thereof.

In specific examples, the grass seed is perennial ryegrass, bluegrass, smooth brome grass, Bermuda grass, hard fescue, tall fescue, Indian ricegrass, Little Blustem grass, Blue Grama grass, Yellow Indiangrass, Arizona/Idaho fescue, Sideoats Grama, Bluebunch Wheatgrass, Big Bluestem grass, Thickspike wheatgrass, Sand Dropseed, Sterile Triticale, Mountain Brome, Slender Wheatgrass, Streambank Wheatgrass, Prairie Junegrass, Bottlebrush Squirreltail, Sandberg Bluegrass, Big/Canby Bluegrass, Rocky Mtn/Idaho fescue, Blue Wildrye, Tufted hairgrass, Alpine Timothy, Alpine/Sandberd Bluegrass, or Switchgrass seeds. In one example, the seed is a mixture of grass seed, such as ‘Sea Spray’ (seashore paspalum) and Poa trivialis (shade tolerant bluegrass). Two, three, four, or more different types of seeds (for example, from different varieties or species) can be included in a mix of seeds. In particular examples, the mixture of seed is adapted for a particular geographic or climactic region (such as forests, grasslands, foothills, or mountains), for example a region burned in a fire. Specific, non-limiting examples of grass seed mixes include High Park Foothills Native Mix, High Park Dry Native Mountain Mix, and High Park Native Mountain Mix (Pawnee Buttes Seed, Inc., Greely, Colo.).

The disclosed compositions can include other agents, such as one or more growth-promoting additives, such as fertilizers, growth hormones, soil-based nutrients, as well as colorants, or combinations thereof.

One specific, non-limiting example of a planting mix composition (for example, in the planting mix used to make seed-encased dough pellets) includes 40% corn flour, 50% fine coir, 2.5% SAP, 2.5% charcoal, 2.5% seed, and 2.5% fungicide (w/w). Another specific, non-limiting example of a planting mix composition includes 50% corn flour, 33% medium coir, 1% SAP, 11% charcoal, 2.5% seed (for example, canola or smooth brome), and 2.5% fungicide (w/w). A further specific, non-limiting example of a planting mix composition is 33% coir, 60% cornmeal or corn flour, 2% SAP, 2.5% charcoal, 2.5% seed (w/w). Other specific, non-limiting examples of a planting mix composition are 40% corn flour, 55% fine coir, 2.5% SAP (for example Zeba®), and 2.5% seed; 40% corn flour, 40% coir, 2.5% SAP (for example Zeba®), 10% compost, 2.5% charcoal, 2.5% fungicide (for example, Captan), and 2.5% seed; 40% corn flour, 42.5% coir, 2.5% SAP (for example Zeba®), 10% compost, 2.5% fungicide (for example, Captan), and 2.5% seed; or 40% corn flour, 42.5% coir, 2.5% SAP (for example Zeba®), 10% compost, 2.5% charcoal, and 2.5% seed. Yet another specific, non-limiting example of a planting mix composition is 50% corn meal, 32% medium coir, 2% SAP, 11% charcoal, 2.5% fungicide, 2.5% seed (for example, canola or smooth brome) (w/w).

Some embodiments of the planting mix composition are formed into a dough that includes corn meal or corn flour and naked seed to form a seed-containing dough, which can be passed through an extruder. In specific, non-limiting examples, the extruded seed-containing dough can be about ¼ inch to about 1 inch in diameter, for example, about ¼ inch, about ⅜ inch, about ½ inch, about ¾ inch, or about 1 inch in diameter. The dough can then be cut to the desired length, such as about ¼ inch to about 1.5 inches in length, for example, about ¼ inch, about ½ inch, about ¾ inch, about 1 inch, or about 1.5 inches in length, and then dried to form seed-encased dough pellets. In one example, the extruded dough is cut into squares or rectangles, such as 7/16″ or ½″ cubes. The resulting square or rectangular pellet has more surface area than a round pellet, and thus has more area touching the earth when planted. Such square or rectangular pellets are less susceptible to removal by wind.

In some examples the number of seeds per dough pellet is 1, 2, 3, 4, 5, 6, 7, 8, 9, or 10 seeds per pellet, such as 3 seeds/pellet to 5 seeds/pellet or 1 to 5 seeds per pellet. In particular examples, the dough pellets contain at least 1 seed, such as at least 3, at least 5, or at least 10 seeds, such as 2, 3, 4, 5, 6, 7, 8, 9, 10, 12, 15, or 20 seeds.

In some embodiments, there are at least 400 seed-encased dough pellets per pound, for example at least 450, at least 500, at least 550, at least 600, at least 650 or more seed-encased dough pellets per pound. In some examples, the method generates seed-encased dough pellets that are that are at least at least 20 lb/bushel density (such as at least 30, at least 40, for example 20-45 or 30-40 lb/bushel density). In further examples, the method generates seed-encased dough pellets that are at least 21, at least 22, at least 23, at least 24, at least 25, at least 26, at least 27, at least 28, at least 29 at least 30, at least 31, at least 32, at least 33, at least 34, at least 35, at least 36, at least 37 lb/bushel density, or more.

The disclosure is not limited to particular seeds. Any plant seed can be encased in the dough pellets, such as those listed above. Exemplary seeds include those that can germinate into flowers, trees, grasses (for example, native grasses) such as fescue (for example fine and tall fescue), seashore paspalum, ryegrass, forage grass, switchgrass, Bermuda grass, smooth brome grass, bluegrass, wheatgrass, and bentgrass, and those used to plant crops (such as soy, canola, beans, cotton, tobacco, tomatoes, corn, melon, rye, carrots, lettuce, and wheat) or any seed that can benefit from this method. In a specific example the seed is a grass seed.

Pelletized coir can be generated from blocks of coir that are ground. For example, ground coir is pelletized in a California pellet mill in order to densify the coir. In some examples, the pelletized coir is screened to roughly the desired size (for example to remove smaller undesired coir pellets). In some examples, coir is ground and pelletized under conditions that result in a density of pelletized coir of at least 40 lb/bushel, at least 50 lb/bushel, such as 40 to 60 lb/bushel. In particular examples, the pelletized coir are about 1 mm to 10 mm in diameter, for example 3 mm to 6 mm in diameter, or 5 mm in diameter. In particular examples, the pelletized coir are about 5 mm in diameter and 5 mm to 10 mm in length. In other examples, the pelletized coir are about ¼ to ½ inch in diameter, about ¼ inch to about 1 inch in diameter (for example about ⅜ inch in diameter, about ½ inch in diameter, or about ¼ inch in diameter). In yet other examples, the pelletized coir are about ¼ to 1 inch in length, about ¼ to ¾ inch in length, about ¼ to ½ inch in length (for example, about ¼ inch, about ½ inch, or about ¾ inch in length). In some embodiments, pellet length is different for different seed species, for example a longer pellet is used with a seed having a longer length. In a particular example, there are 550 coir pellets per pound. In yet another example, the density of the pelletized coir is about 42 lb/bushel.

In particular examples, the pelletized coir does not have cavities greater in diameter than the diameter of the seed. For example, the pelletized coir is not subjected to a treatment that purposefully introduces cavities or wells into which seed can be deposited, and then the cavity sealed or closed. Instead, the seeds are adhered to the outer surface of the pelletized coir, and are not inserted in cavities created in the surface of the pelletized coir. In one example, the compositions include pelletized coir at least partially coated with seeds adhered to the pelletized coir by a binder, and optionally, a super-absorbent polymer (SAP) adhered to the pelletized coir by a binder. In one example, the SAP is not a starch-based SAP. In some examples, the seeds adhered to the pelletized coir by a binder are at least partially coated with a super-absorbent polymer (SAP) and/or charcoal. In one example, the SAP adhered to the seed or used in the planting mix composition can include about 0.5% to 5% SAP or 1 to 5% SAP, such as 2 to 5%, 2.5 to 5%, 1.5 to 2.5%, or 3 to 5% SAP by weight of the seed. In one example, the SAP adhered to the pelletized coir can include about 0.5% to 5% SAP or 1 to 5% SAP, such as 2 to 5%, 2.5 to 5%, 1.5 to 2%, 1.5 to 2.5%, or 3 to 5% SAP by weight of the pelletized coir.

Exemplary binders include partially water-soluble binders, such as PVOH or lignosulfanate. Various ratios of the binder to pelletized coir can be present in the composition. In some examples, the binder and pelletized coir are present in the composition at a ratio of about 85% coir to 15% binder by weight, or about 50% each by weight (that is a ratio of about 1 to 1). In some examples, the pelletized coir:binder ratio in the composition is about 2 to 1, 3 to 1, 4 to 1, 5 to 1, 10 to 1, 15 to 1, 18 to 1, 20 to 1, 25 to 1, 30 to 1, 35 to 1, 36 to 1, 1 to 2, 1 to 3, 1 to 5, or 10 to 5 by weight. In a specific example, the pelletized coir:binder ratio is about 15 to 1 to 40 to 1, such as 18 to 1 to 36 to 1, by weight.

An adhesive or binder can be used to adhere the Zeba® coating or other SAP to the seed or pelletized coir, by creating a favorable moist surface for the SAP-containing composition (e.g., Zeba® powder and filler material). Because Zeba® is a superabsorbent product and absorbs water very readily, polyvinyl alcohol (PVOH) can be used as the binder (Celvol® or BF17). For example, a rate of 1.5 to 2.5 pounds of powder PVOH to 100 pounds of grass seed can be used to provide a sufficiently moist surface for the SAP-containing composition to adhere. In one example, raw seed is exposed to PVOH binder for 60 to 90 seconds at 70 to 90° F. (e.g., room temp) to obtain thorough coverage on each seed.

In one example, the ratio of the pelletized coir to the seeds attached to the surface of the pellets is at least 3:1 by weight, such as at least 4:1, at least 5:1, at least 8:1, at least 10:1, at least 50:1 at least 100:1, at least 250:1 or at least 500:1 by weight, for example about 3:1, 4:1, 5:1, 8:1, 10:1, 47:1, 50:1, 100:1, 200:1, or 500:1 by weight. In some examples the coir:seed ratio is about 500:1 by weight (e.g., for Bermuda grass seed) or 47:1 by weight, (e.g., for smooth brome grass seed). In some examples the number of seeds per pellet is 1, 2, 3, 4, 5, 6, 7, 8, 9, or 10 seeds per pellet, such as 3 seeds/pellet to 5 seeds/pellet or 1 to 5 seeds per pellet. In particular examples, the binder-coated pelletized coir contains at least 1 coated seed, such as at least 3, at least 5, or at least 10 coated seeds, such as 2, 3, 4, 5, 6, 7, 8, 9, 10, 12, 15, or 20 seeds.

In some examples, the ratio of coir to seed or pellet to seed (such as a coir pellet or dough pellet) is determined by the plant density desired in the field. For example, for tall fescue or Bermuda grass (for example, for pasture, grassland, or rangeland) with a desired 1 plant per sq. foot (43,560 per acre), 2-3 seeds are applied per coir pellet or are encased in a dough pellet, and to achieve 126,000 seeds per acre (there are 250,000 seeds/lb of seed), 1 to 1.5 lb seed per acre is needed. This is in contrast to raw seed, which one might use at a ratio of 10-20 lb seed/acre (and which have reduced establishment, compared seeds encased in, or applied to, pellets). For turf, to achieve one plant per sq. inch, with 4 seeds per pellet, approximately 144 pellets are planted per sq foot, thus 24 lb pellets per 1000 sq feet.

In another example, the ratio of ground coir to seed is about 3:1 by weight, such as 4 to 1 by weight, about 5 to 1 by weight, or about 10 to 1 by weight. In yet another example, the ratio of a mix of pelletized coir and ground coir to seed is about 3:1 by weight, such as 4 to 1 by weight, about 5 to 1 by weight, or about 10 to 1 by weight.

The disclosed compositions can include other agents, such as one or more growth-promoting additives, such as fertilizers, pesticides (such as a fungicide), growth hormones, soil-based nutrients, activated charcoal, compost, inoculate of beneficial bacteria, mycorhizzae, or combinations thereof, as well as colorants.

In some examples, the pelletized coir or coated seed can also include adhered activated charcoal. The activated charcoal can be adhered to the pelletized coir or seed along with the SAP or can be adhered to the seed via the binder in a separate step. In a particular example, the ratio of activated charcoal to seed is at least a 1:1 ratio by weight of charcoal to seed, for example at least a 2 to:1, at least 5 to 1, at least 10:1 at least 15 to 1, at least 20 to 1, at least 25 to 1 or at least 30 to 1 (such as a ratio of about 2 to 1, 4 to 1, 5 to 1, 10 to 1 or 29 to 1).

In particular embodiments, various ratios of ground coir to pelletized coir can be present in the composition. In some examples, the ground coir and pelletized coir are present in the composition at a ratio of about 85% ground coir to 15% pelletized coir by weight, or about 50% each by weight (that is a ratio of about 1 to 1). In some examples, the ground coir:pelletized coir ratio in the composition is about 2 to 1, 3 to 1, 4 to 1, 5 to 1, 10 to 1, 15 to 1, 18 to 1, 20 to 1, 25 to 1, 30 to 1, 35 to 1, 36 to 1, 1 to 2, 1 to 3, 1 to 5, or 10 to 5 by weight. In a specific example, the ground coir:pelletized coir ratio is about 15 to 1 to 40 to 1, such as 18 to 1 to 36 to 1, by weight. In some examples such a composition is used to seed an area, such as to reseed turf. In some examples, a spreader is used to apply such a composition, for example to about ⅛ inch thick.

In particular examples, the composition includes ground coir or coir pellets made from ground coir, seeds, and a SAP. In one example the ratio of seed to coir (such as ground coir or coir pellets) is 1:10 by weight. In other examples, there are at least 1 seed, at least 2 seeds, at least 3 seeds, at least 4 seeds, at least 5 seeds, at least 6 seeds, at least 7 seeds, at least 8 seeds, at least 9 seeds, at least 10 seeds, or more per pelletized coir. In some examples, the composition includes at least 0.5% SAP, at least 1% SAP, at least 2% SAP, such as 1-2% SAP (such as 1-2% Zeba®) (w/w).

When seeds are adhered to a core pellet and coated with activated charcoal, or when seeds are encased in a pellet comprised of coir and activated charcoal, the seed has a good environment for sprouting, surviving, and tolerating herbicides such as Karmex (Diuron), Atrazine, or Kerb. This results in superior stands in adverse conditions while killing existing sprouting weed seeds. For example, inclusion of activated charcoal in the disclosed compositions can increase the herbicide resistance of the seed, such as an increase of at least 10%, at least 25%, at least 50%, at least 75%, at least 90% or at least 99%. For example, when such compositions are planted, the crop or other seed- or plant-containing area can be treated with one or more herbicides to reduce undesirable weed growth, without significantly affecting the viability of the coated seeds. This results in a crop or other treated area that is virtually weed-free (for example less than 0.05% weeds, less than 0.5% weeds, or less than 0.1% weeds). In particular examples, activated charcoal can increase resistance to the following herbicides: atrazine, Karmex, and Kerb.

In some examples, the disclosed compositions increase germination of seed present in the composition, compared to naked seed planted in the absence of the composition. In some examples, the disclosed compositions are mixed with seed prior to planting. In yet other examples, the disclosed compositions include seed at least partially coated with SAP (herein referred to as “coated seed”). In some examples the seed, or coated seed, is adhered to the pelletized coir with a binder. In some examples, the seed is at least partially coated with SAP (and in some examples also charcoal). In particular examples, the seed is coated prior to adhering it to the pelletized coir. In other examples, the seed adhered to the composition is at least partially coated with SAP when it is being adhered to the pelletized coir. In particular examples, seed present in the disclosed compositions, for example the ground coir-containing compositions, pelletized coir-containing compositions, or seed-encased dough pellets have increased germination, for example as compared to (i) normal or “uncoated” seed; (ii) coated seed in the absence of the other components of the composition; (iii) seed mixed with or adhered to other planting compositions; or (iv) seed planted directly in the ground in the absence of a planting composition. In particular examples, seed-encased dough pellets have increased germination compared to seed attached to the surface of pellets.

In some embodiments, increased seed germination is an increase in the number of seeds sprouting a radicle, a primary root, a hypocotyl, a cotyledon, or a combination thereof, compared to seed germinated in the absence of the planting composition. The increase in seed germination can be at least 20%, at least 30%, at least 40%, at least 50%, at least 75%, at least 80%, at least 90%, or at least 100%. In some examples, increased seed germination is germination of at least 70%, at least 75%, at least 80%, at least 85%, at least 90%, at least 95%, at least 96%, at least 97%, at least 98%, at least 99%, or 100% of the seeds in the planting composition, compared to seed germinated in the absence of the planting composition. In other examples, increased seed germination is evidenced by one or more of increased seed germination rate (for example, increased number of seeds germinating over time), earlier seed germination (for example, increased number of seeds germinating at an earlier date), decreased irrigation requirements, increased seed crop growth, or increased seed crop production, compared to seed germinated in the absence of the planting composition. In particular embodiments, increased seed germination is an increase in primary root growth, radicle growth, hypocotyl growth, cotyledon growth, or a combination thereof, compared to a seed in the absence of the planting composition.

In other embodiments, the disclosed compositions increase the establishment of seeds, for example seedlings sprouted from seed planted with the composition have a higher rate of establishment, compared to seedlings sprouted from seed planted in the absence of the composition. In particular examples, seed present in the disclosed compositions, for example the ground coir-containing compositions, pelletized coir-containing compositions, or seed-encased dough pellets have a higher rate of establishment, for example as compared to (i) normal, naked, or “uncoated” seed; (ii) coated seed in the absence of the other components of the composition; (iii) seed mixed with or adhered to other planting compositions; or (iv) seed (coated or uncoated) planted directly in the ground in the absence of a planting composition. In some embodiments, increased establishment is an increase in the number of seeds sprouting a cotyledon, a hypocotyl, an epicotyl, leaves, a primary root, secondary roots, flowers, or a combination thereof, compared to seed in the absence of the planting composition. The increase in establishment can be at least 20%, at least 30%, at least 40%, at least 50%, at least 75%, at least 80%, at least 90%, at least 96%, at least 97%, at least 98%, at least 99%, or at least 100%. In some examples, increased establishment is establishment of at least 70%, at least 75%, at least 80%, at least 85%, at least 90%, at least 95%, at least 96%, at least 97%, at least 98%, at least 99%, or 100% seedlings sprouted from seed in the planting composition, compared to seed in the absence of the planting composition. In other examples, increased establishment is evidenced by, for example, increased cotyledon size, increased primary root length, increased secondary root length, increased number of secondary roots, increased hypocotyl length, increased epicotyl length, increased leaf size, increased blooming, decreased irrigation requirements, or a combination thereof, compared to seed in the absence of the planting composition. In other examples, increased establishment is evidenced by one or more of increased rate of establishment (for example, increased number of established seedlings over time), earlier establishment (for example, increased number of seedlings established at an earlier date), increased seed crop growth, or increased seed crop production, compared to seed germinated in the absence of the planting composition.

In some embodiments, germination starts in about 3-12, about 3-10, about 3-7, about 3-5, about 5-7, about 5-10, or about 5-12 days, for example in about 3, about 4, about 5, about 6, about 7, about 8, about 9, or about 10 days. In other embodiments, 90% of the seeds are germinated in about 5-20, about 5-15, about 5-12, about 5-10, about 5-7, about 7-10, about 7-12, or about 7-15 days, for example, in about 5, about 6, about 7, about 8, about 9, about 10, about 11, about 12, about 13, about 15, or about 20 days. In yet other embodiments, 95% of the seeds are germinated in about 5-20, about 5-15, about 5-12, about 5-10, about 5-7, about 7-10, about 7-12, or about 7-15 days, for example, in about 5, about 6, about 7, about 8, about 9, about 10, about 11, about 12, about 13, about 15, or about 20 days. In further embodiments, 98% of the seeds are germinated in about 5-20, about 5-15, about 5-12, about 5-10, about 5-7, about 7-10, about 7-12, or about 7-15 days, for example, in about 5, about 6, about 7, about 8, about 9, about 10, about 11, about 12, about 13, about 15, or about 20 days. In other embodiments, 99% of the seeds are germinated in about 5-30, about 5-25, about 5-20, about 5-15, about 5-12, about 5-10, about 5-7, about 7-10, about 7-12, about 7-15, about 7-20, about 7-25, or about 7-30 days, for example, in about 5, about 6, about 7, about 8, about 9, about 10, about 11, about 12, about 13, about 15, about 20, about 25, or about 30 days. In other embodiments, 100% of the seeds are germinated in about 5-30, about 5-25, about 5-20, about 5-15, about 5-12, about 5-10, about 5-7, about 7-10, about 7-12, about 7-15, about 7-20, about 7-25, or about 7-30 days, for example, in about 5, about 6, about 7, about 8, about 9, about 10, about 11, about 12, about 13, about 15, about 20, about 25, or about 30 days.

In particular examples, increased primary root growth is an increase in length of the primary root, for example a length of at least 1.0 inch, at least 1.1 inches, at least 1.2 inches, at least 1.3 inches, at least 1.4 inches, at least 1.5 inches, at least 1.6 inches, at least 1.7 inches, at least 1.8 inches, at least 1.9 inches, at least 2.0 inches, at least 2.1 inches, at least 2.2 inches, at least 2.3 inches, at least 2.4 inches, at least 2.5 inches, at least 2.6 inches, at least 2.7 inches, at least 2.8 inches, at least 2.9 inches, at least 3.0 inches, at least 3.5 inches at least 4.0 inches or more, compared to a seed in the absence of the planting composition. In other particular examples, increased hypocotyl growth is an increase in length of the hypocotyl, for example a length of at least 1.0 inch, at least 1.1 inches, at least 1.2 inches, at least 1.3 inches, at least 1.4 inches, at least 1.5 inches, at least 1.6 inches, at least 1.7 inches, at least 1.8 inches, at least 1.9 inches, at least 2.0 inches, at least 2.1 inches, at least 2.2 inches, at least 2.3 inches, at least 2.4 inches, at least 2.5 inches, at least 2.6 inches, at least 2.7 inches, at least 2.8 inches, at least 2.9 inches, at least 3.0 inches, at least 3.5 inches at least 4.0 inches or more, compared to a seed in the absence of the planting composition.

In some embodiments, seed in the disclosed planting mix composition is germinated at one or more temperatures in a 24 hour cycle. In some embodiments, seed is germinated at about 18° C., about 19° C., about 20° C., about 21° C., about 22° C., about 23° C., about 24° C., about 25° C., about 26° C., about 27° C., about 28° C., about 29° C., about 30° C., about 31° C., about 32° C., about 33° C., about 34° C., or about 35° C. or more. In other embodiments, seed can be germinated at any particular temperature for at least 6, at least 7, at least 8, at least 9, at least 10, at least 11, at least 12, at least 13, at least 14 at least 15, at least 16, at least 17, or at least 18 hours. In further embodiments, seed can be germinated under conditions of 12 hr lights on/12 hr lights off. In other embodiments, seed can be germinated under conditions of 6 hr lights on/18 hr lights off, 7 hr lights on/17 hr lights off, 8 hr lights on/16 hr lights off, 9 hr lights on/15 hr lights off, 10 hr lights on/14 hr lights off, 11 hr lights on/13 hr lights off, 13 hr lights on/11 hr lights off, 14 hr lights on/10 hr lights off, 15 hr lights on/9 hr lights off, 16 hr lights on/8 hr lights off, 17 hr lights on/7 hr lights off, 18 hr lights on/6 hr lights off, in a 24 hour cycle.

In one particular embodiment, seed is germinated at least at 20° C. for about 16 hr and for at least 30° C. for about 8 hr in a 24 hour cycle. In a further embodiment, seed is germinated at least at 20° C. for about 16 hr with lights off and for at least 30° C. for about 8 hr with lights on. In another particular embodiment seed is germinated at least at 20° C. for 14 hr and for at least 30° C. for 10 hr in a 12 hr light on/12 hr light off cycle. In a further embodiment seed is germinated at least at 20° C. for 14 hr with lights off and for at least 30° C. for 10 hr with lights on.

In some embodiments, the seed present in the disclosed compositions has an increased germination rate, for example a germination rate that is at least 20%, at least 30%, at least 40%, at least 50%, at least 75%, or at least 100% greater than seed planted in the absence of the planting composition. In other embodiments, the increased germination rate is germination of at least 70%, at least 75%, at least 80%, at least 85%, at least 90%, at least 95%, at least 96%, at least 97%, at least 98%, at least 99%, or 100% of the seeds in the planting composition, compared to seed germinated in the absence of the planting composition. In yet other embodiments, the seed present in the disclosed compositions has an earlier germination, for example a germination that is at least 1 day, at least 2 days, at least 3 days, at least 5 days, at least 7 days, or at least 14 days earlier than seed planted in the absence of the planting composition.

In particular examples, the coated seed present in the disclosed compositions has an increased germination rate, for example a germination rate that is at least 20%, at least 30%, at least 40%, at least 50%, at least 75%, at least 80%, at least 90%, or at least 100% greater than normal uncoated seed or to coated seed in the absence of the other components of the composition. In some examples, the seed present in the disclosed compositions has an earlier germination, for example a germination that is at least 1 day, at least 2 days, at least 3 days, at least 5 days, at least 7 days, or at least 14 days earlier than normal uncoated seed or to coated seed in the absence of the other components of the composition.

In a specific example, the composition includes seed at least partially coated with an alcohol-based binder (such as PVOH), to which a SAP-containing composition is adhered (such as a SAP-containing composition that includes 1 to 5% SAP, such as 1.5 to 1.5% SAP, for example Zeba®). In another specific example, the composition includes activated charcoal, for example a ratio of at least 1:1 (w/w) of activated charcoal to seed, such as a ratio of at least 2:1, at least 3:1, at least 5:1, at least 7:1 or at least 10:1 (w/w).

### Methods of Producing a Planting Mix

Methods of producing a planting mix are provided. In particular examples, the planting mix increases the germination of seed in the planting mix, such as an increase in the germination and/or establishment rate, an earlier germination and/or establishment date, or combinations thereof. Indications of increased germination include, but are not limited to, earlier seed germination, decreased irrigation requirements, increased crop growth, increased crop production or yield, increased germination rate, or combinations thereof. Indications of increased establishment include, but are not limited to, increased cotyledon size, increased primary root length, increased secondary root length, increased number of secondary roots, increased hypocotyl length, increased epicotyl length, increased leaf size, increased blooming, decreased irrigation requirements, increased crop growth, increased crop production or yield, or a combination thereof. For example, increased germination and/or establishment can be relative to naked seed (e.g., seed not adhered to pelletized coir, seed not encased in a dough pellet, or seed not mixed with a disclosed planting composition) or to seed not containing SAP, such as an increase of at least 20%, at least 40%, at least 50%, at least 75%, at least 80%, at least 90% or at least 95%.

In particular examples, the method includes adhering seed and activated charcoal to pelletized coir using a binder, for example pelletized coir at least partially coated with a binder, thereby generating a planting mix. In particular examples, adhering the seed and activated charcoal to pelletized coir using a binder includes mixing the pelletized coir and then adding a first amount of binder to the pelletized coir. This can result in at least partial coating of the coir by the binder. Subsequently, seed is added to the binder-pelletized coir mixture. Charcoal is added to the seed-binder-pelletized coir mixture, followed by adding a second amount of binder. It is shown herein the addition of the components in this order enhances coating of the pelletized coir and attachment of the seeds and charcoal. In some embodiments, the charcoal is not added if the seed has herbicide-resistance.

In particular examples, the method further includes adhering a super-absorbent polymer (SAP) to the pelletized coir using the binder.

In particular examples, the seed is at least partially coated with a super-absorbent polymer (SAP) prior to attaching the seed to the pelletized coir. In particular examples, adhering the SAP, seed, and activated charcoal to pelletized coir using a binder includes mixing the pelletized coir and then adding a first amount of binder to the pelletized coir. This can result in at least partial coating of the coir by the binder. Subsequently, seed is added to the binder-pelletized coir mixture. Charcoal is added to the seed-binder-pelletized coir mixture, followed by adding a second amount of binder. Subsequently, the SAP is added to the charcoal-seed-binder-pelletized coir mixture. It is shown herein the addition of the components in this order enhances coating of the pelletized coir and attachment of the seeds, SAP and charcoal.

The method can also include generating the ground and/or pelletized coir. For example, ground coir can be obtained by grinding blocks of coir to achieve at least 15 lb/bushel density, such as at least 20 lb/bushel density, at least 25 lb/bushel density, at least 30 lb/bushel density, at least 40 lb/bushel, at least 45 lb/bushel, at least 50 lb/bushel, or at least 60 lb/bushel, such as about 15 to 30 lb/bushel density, about 15-45 lb/bushel, about 30-45 lb/bushel, about 35-45 lb/bushel, about 40-45 lb/bushel, or about 40-60 lb/bushel, thereby generating ground coir. In some embodiments the ground coir is compressed (for example in a California pellet mill) to achieve at least 20 lb/bushel density, such as at least 25 lb/bushel density, at least 30 lb/bushel density, at least 35 lb/bushel, at least 40 lb/bushel, at least 42 lb/bushel, at least 45 lb/bushel, at least 47 lb/bushel, at least 50 lb/bushel density, at least 60 lb/bushel density, or at least 80 lb/bushel density, such as about 40 to 60 lb/bushel density, such as about 45 lb/bushel density, thereby generating pelletized coir. In some embodiments the resulting pelletized coir is further ground, for example, pelletized coir is 15-45 lb/bushel and the coir maintains this density when ground.

In other embodiments, the method of pelletizing coir includes preparing pelletized coir that has seed embedded or encased within the pellet. In one particular embodiment of the method, the seed is mixed with the disclosed planting mix components (including ground coir, corn flour, SAP, compost, charcoal, fertilizers, pesticides, fungicide, growth hormones, soil-based nutrients, nitrogen, potassium, phosphorous, colorants, or combinations thereof) to form a dough. The dough (which includes the seed) is passed through an extruder, such as a food grinder, and cut into pellets (dough pellets). The diameter of the pellets is dependent upon the die used in the extruder. For example, the dough pellets can be about ¼ to 1 inch in diameter, about 1 inch in diameter, about ¾ inch in diameter, about ½ inch in diameter, about ⅜ inch in diameter, or about ¼ inch in diameter. In yet other examples, the dough pellets are about ¼ to 1.5 inch in length, about ¼ to 1 inch in length, about ¼ to ¾ inch in length, about ¼ to ½ inch in length, about ¼ inch, about ⅜ inch, about ½ inch, about ¾ inch, about 1 inch, or about 1.5 inches in length. In one example, the extruded dough is cut into squares or rectangles, such as 7/16″ or ½″ cubes. The resulting square or rectangular pellet has more surface area than a round pellet, and thus has more area touching the earth when planted. Such square or rectangular pellets are less susceptible to removal by wind.

After the seed is attached to the pelletized coir, or after the dough pellets are formed, the composition can be dried. For example, drying can significantly reduce imbibing of moisture by the seed, thereby reducing unwanted pre-germination. In addition, drying can rapidly draw-off moisture without using excessive heat (which can kill the seed). Methods of drying and drying equipment are known in the art, for example using ambient air, a large fluid bed dryer, forced hot air system, grain bins, or the like. Depending on the type of drying method or equipment, temperatures for drying can be as high as 130° F. for a short time, such as about 30 seconds to about 60 seconds, about 30 seconds to about 90 seconds, about 1 to 2 minutes, about 1 to 3 minutes, about 1 to 4 minutes, about 1 to 5 minutes, about 2-3 minutes, about 2-4 minutes, about 3-5 minutes, or more. In other embodiments, depending on the type of drying method or equipment, temperatures for drying can be as high as 130° F. for one or more hours or days, for example at least about 1 hour, at least about 2 hours, at least about 3 hours, at least about 4 hours, at least about 5 hours, at least about 6 hours, at least about 7 hours, at least about 8 hours, at least about 9 hours, at least about 10 hours, at least about 11 hours, at least about 12 hours, at least about 13 hours, at least about 14 hours, at least about 15 hours, at least about 16 hours, at least about 17 hours, at least about 18 hours, at least about 19 hours, at least about 20 hours, at least about 21 hours, at least about 22 hours, at least about 23 hours, at least about 24 hours, at least about 36 hours, at least about 48 hours, at least about 72 hours, at least about 4 days, at least about 5 days, at least about 6 days, at least about 7 days, or more. In other embodiments, depending on the type of drying method or equipment, temperatures for drying can be as high as 130° F. for one or more hours or days, for example about 1-72 hours, about 1-48 hours, about 1-24 hours, about 6-12 hours, about 6-24 hours, about 6-48 hours, about 6-72 hours, about 8-12 hours, about 8-24 hours, about 8-48 hours, or about 8-72 hours, about 12-24 hours, about 12-36 hours, about 12-48 hours, about 12-72 hours, about 7-12 hours, about 8-12 hours, about 9-12 hours, about 10-12 hours, about 11-12 hours, about 9-13 hours, about 10-14 hours, about 11-15 hours, about 12-16 hours.

After drying, the composition (for example, the coir pellets or dough pellets) can be screened for size, and can be bagged. In particular examples, the composition can be screened using the screens. The desired-sized particles can be selected, for example fine particulate can be discarded.

In some examples, the method further includes adding compost or other agent described above to the planting mix (such as an insecticide, herbicide, nitrogen, charcoal, SAP, colorant or combinations thereof).

In particular examples, the method can further include planting the planting mix, thereby permitting germination of the seed and in some examples improving germination and/or establishment of the seed. Thus, the disclosed compositions can be planted, resulting in improved germination or even improved establishment of the seed. In some examples, disclosed coir pellets or extruded dough pellets are planted in an environment traditionally considered unfavorable for seed germination and growth, such as snow, mud, on top of dry dirt (e.g., at times of drought), or in areas recently scourged by fire. Based on the results presented herein, it is expected that the disclosed planting mixes can be broadcast from an aircraft where vehicle traffic is not possible because of excessive moisture (e.g., the planting mixes applied to snowy or muddy areas). Based on these results, it is expected that the disclosed coir pellets or extruded dough pellets can be planted onto soils with high levels of trash and organic matter on the surface, left there to retain moisture, and will successfully germinate and establish. Similar methods can be used to plant the disclosed coated pellets onto pasture that needs to be reseeded. Prior to broadcasting (planting) the areas to be planted can be treated with glyphosate to kill the previous crops or weeds.

As discussed above, in particular examples the pelletized coir does not have cavities greater in diameter than the diameter of the seed. Thus, in some examples the method does not include introducing cavities or wells into the coir, for example by a machine, for example cavities that are about the size of the seed. In some examples the seeds are not within the pelletized coir if the pelletized coir does not also contain corn flour or corn meal. Thus, in some examples, the method does not include compressing seeds with the coir.

In particular examples, the ratio of the pelletized coir to the seeds is at least 3:1 by weight, such as at least 4:1, at least 5:1, at least 6:1, at least 7:1, at least 8:1, at least 9:1, at least 10:1, at least 40:1, at least 100:1, at least 250:1 at least 500:1, such as 10:1 to 500:1. In some examples the average number of seeds attached to the pelletized coir is 1, 2, 3, 4, 5, 6, 7, 8, 9, 10, 11, 12, 13, 14, 15, 16, 17, 18, 19, or 20 seeds, such as 1 to 10 or 3 to 5 seeds.

As discussed above, the disclosure is not limited to use of particular seeds. Seeds from any plant can be used. Exemplary seeds are described above. In addition, the seed can include a mixture of different types of seeds, such as a mixture of different grass seeds, different wildflower seeds, different legumes, different crop seeds, or any combination thereof. In one example, the seed is a canola seed.

In specific examples, the grass seed is perennial ryegrass, bluegrass, smooth brome grass, Bermuda grass, hard fescue, tall fescue, Indian ricegrass, Little Blustem grass, Blue Grama grass, Yellow Indiangrass, Arizona/Idaho fescue, Sideoats Grama, Bluebunch Wheatgrass, Big Bluestem grass, Thickspike wheatgrass, Sand Dropseed, Sterile Triticale, Mountain Brome, Slender Wheatgrass, Streambank Wheatgrass, Prairie Junegrass, Bottlebrush Squirreltail, Sandberg Bluegrass, Big/Canby Bluegrass, Rocky Mtn/Idaho fescue, Blue Wildrye, Tufted hairgrass, Alpine Timothy, Alpine/Sandberd Bluegrass, or Switchgrass seeds. In one example, the seed is a mixture of grass seed, such as ‘Sea Spray’ (seashore paspalum) and Poa trivialis (shade tolerant bluegrass). In particular examples, the mixture of seed is adapted for a particular geographic or climactic region, for example a region (such as forests or grasslands) burned in a fire. Two, three, four, or more different types of seeds (for example, from different varieties or species) can be included in a mix of seeds. Specific, non-limiting examples of grass seed mixes include High Park Foothills Native Mix, High Park Dry Native Mountain Mix, and High Park Native Mountain Mix (Pawnee Buttes Seed, Inc., Greely, Colo.).

As described above, binders known in the art can be used. In one example, the binder is water soluble. In specific examples the binder comprises PVOH or lignosulfansate.

Also as discussed above, the disclosure is not limited to use of particular SAPs. Any SAP can be used in the planting mix composition, for example in the planting mix used to make the coir pellets or dough pellets, as long as it is not significantly toxic to the seeds or plants. Exemplary SAPs are described above. For example, the SAP can be a starch-based SAP, such as Zeba®, or a non-starched based SAP. In a particular example, the seed and/or pelletized coir are at least partially coated with a binder to which a SAP can adhere. In particular examples, the SAPs are present in a SAP-containing composition that is incubated with the at least partially binder-coated seeds or pelletized coir, such as a composition that includes SAP at a concentration of 1 to 5% of the weight of the seed, such as 1% to 5%, 2 to 3% or 1.5 to 2.5% of the weight of the seed. In one example, the SAP adhered to the pelletized coir can include about 0.5% to 5% SAP or 1 to 5% SAP, such as 2 to 5%, 2.5 to 5%, 1.5 to 2%, 1.5 to 2.5%, or 3 to 5% SAP by weight of the pelletized coir. In some examples, the SAP-containing composition adhered to the seeds also further includes activated charcoal, for example a ratio of about 1:1 or 10:1 (w/w) of activated charcoal to seed, or in an amount of about 1% to 10% activated charcoal (w/w), for example about 2.5% activated charcoal (w/w). In some examples, an approximately equal weight of the SAP particles are adhered to an approximately equal weight of the seed. In some examples, charcoal is added to equal 300 lbs/acre for herbicide protection. Round or square pellets can be formulated to provide the rate/square inch.

In a particular example, the ratio of activated charcoal added to the seed is at least a 1:1 ratio by weight of charcoal to seed, for example at least a 2 to:1, at least 5 to 1, at least 10:1 at least 15 to 1, at least 20 to 1, at least 25 to 1 or at least 30 to 1 (such as a ratio of about 2 to 1, 4 to 1, 5 to 1, 10 to 1 or 29 to 1), or in an amount of about 1% to 10% activated charcoal (w/w), for example about 2.5% activated charcoal (w/w).

In particular examples, the method of making a planting mix includes mixing the composition described above (such as those including the pelletized coir containing seeds and charcoal and/or SAP, or those including ground coir, seed, corn flour, charcoal, compost, SAP, and/or fungicide) with other agents, such as compost, thereby generating a planting mix. In one embodiment, fine grade coir and medium grade coir is mixed, seed is added in a ratio of 10:1 (coir:seed) and is spread ⅛ inch thick on the planting surface.

In very specific examples, the method includes coating grass seed and pelletized coir at least partially with a binder (resulting in coated pelletized coir); adhering a SAP-containing composition (such as a composition that includes 1-5% SAP, for example 1.5%-2.5% SAP by weight of the seed, and in some examples optionally includes at least 1:1 (w/w) activated charcoal:seed) to the seed, and adhering the coated seed to the coated pelletized coir, thereby generating a planting composition. In particular examples, the same binder is adhered to the grass seed and the coir.

### Coating Seeds and Pelletized Coir

Methods of coating a seed and pelletized coir are known in the art. For example, commercially available coating equipment is capable of producing a coating on the seed and pelletized coir. Exemplary types of coating equipment are a ribbon/paddle blender, an inclined rotary pan-type, and a rotostat mixing chamber.

In particular examples, an adhesive or binder is first applied to the pelletized coir (or seeds if they are to be separately coated before adhering them to the coir) under conditions that permit at least partial coating of the pelletized coir (or seeds) with the binder. This will allow activated charcoal and seeds or other agent (such as a SAP) to adhere to the coated pelletized coir, or the coated seeds to adhere to the pelletized coated coir, for example by creating a favorable moist surface for the agent to adhere. For example, raw seed or pelletized coir can be exposed to the binder for a time sufficient to obtain at least partial coverage (for example at least 10%, at least 20%, at least 50%, at least 75%, at least 90%, or at least 99% coverage) on each pelletized coir (or seed) particle. Typically, exposure to the binder occurs at room temperature (such as about 20-30° C.). In particular examples, the raw seed or coir pellets are exposed to the binder for at least 10 seconds (e.g., enough to soften pellet, generally under 60 seconds), such as at least 20 seconds, at least 30 seconds, or at least 60 seconds, no more than 120 seconds, no more than 60 seconds, such as 10 to 90 seconds, 10 to 60 seconds, or 10 to 30 seconds.

In some examples, the binder material is inert to the seed, for example does not significantly impair seed germination. In particular examples, the binder is alcohol-based, and in some examples at least partially water soluble. Such binders are known in the art. Exemplary binders that can be used with the compositions and methods provided herein include polyvinyl alcohol (PVOH) or a similar material within the same class used in the seed coating industry (such as polyvinyl acetate and others within this category). Most binders, such as PVOH, come in a powder form which can be mixed into the appropriate solution before use. For example, PVOH adhesives, such as the powder products Celvol® (Celanese Corporation) and BF17 (Kel Chemical), are known in the art. Liquid versions of these products can be used if mixing a solution from the powder form is not desirable. Other exemplary binders include Soil Moist (JRM Chemical, Cleveland, Ohio) and lignosulfonate.

The amount of binder solution applied to the seeds and pelletized coir can affect the quality of the coating: too much binder will result in lumps, while inadequate amounts of binder will cause the coating to dust off, offer low durability and low buildup. Ideally, the adhesive will not impair seed germination, will give seeds or pelletized coir a durable coating when dry, and will be readily soluble in water.

In particular examples, the amount of binder added is about 1% to 10% in weight of the total seed or pelletized coir to be coated, such as about 1% to 5%, or about 1.5% to 2.5%. In some examples, the ratio of coir to binder added is at least 2:1, at least 10:1, at least 18:1, at least 20:1, at least 30:1, at least 36:1 or at least 40:1. In some examples, the larger the seed or pelletized coir to be treated, the higher the percentage of binder used. For example, using 5 to 6 pounds of PVOH to 100 pounds of alfalfa or grass seeds provides a sufficiently moist surface for the filler composition to adhere. Those skilled in the art appreciate how to determine optimal amounts of binder and moisture levels to use.

In some examples, the binder is added at two separate times during the coating process. For example, pelletized coir can be mixed with a fraction of the total amount of binder used (for example a first amount that is at least 30% at least 40%, at least 50%, at least 60%, at least 70%, at least 80%, or at least 90% of the total amount of binder to be added). This at least partially coats the coir with the binder. Subsequently seed and charcoal are added, allowing them to bind to the at least partially coated coir. Subsequently, the remaining portion of the binder is added (for example a second amount that is no more than 50%, no more than 40%, no more than 30%, no more than 20%, or no more than 10% of the total amount of binder to be added). If SAP is to be added, it can be added after the second amount of binder.

If seeds are to be pre-coated with SAP prior to adhering to the coir, the seeds, can be at least partially coated with binder and exposed to a SAP under conditions that permit SAPs to adhere to the seed, and in some examples also permits activated charcoal to adhere to the seed. In particular examples, the SAP-containing composition includes finely ground mineral material, which will adhere to the moist surface of the seed, thereby coating the seed. Among the exemplary particulate solids that can be included in the SAP-containing composition (which can be attached to seeds and/or pelletized coir) are calcium carbonate, clay, gypsum, bentonite, and dry diatomaceous earth.

If desired, other additives can be included in the SAP-containing composition to be applied to the seeds or pelletized coir, or added to the planting compositions provided herein. Particular examples include growth-promoting agents, such as agents that increase the survival rate and health of the young plants. Examples include nutrients, fertilizers, fungicides, herbicides, pesticides, trace elements, growth hormones, inoculate of beneficial bacteria, mycorhizzae, or combinations thereof. Nutrients routinely used in commercial grass seed coatings include but are not limited to N, P, K, S, Fe and Zn. In acidic soils, lime coatings for seeds can be beneficial to seedling performance.

In a particular example, activated charcoal is also adhered to the binder on the pelletized coir (or seeds). For example, activated charcoal can be present alone or in the SAP-containing composition, for example present at a ratio of at least 1:1 (w/w) activated charcoal:seed, such a ratio of at least 2:1, at least 4:1, at least 10:1, or at least 29:1. Alternatively, activated charcoal can be adhered to pelletized coir (or seeds) separately from the SAP containing-composition. For example, the amount of activated charcoal exposed to the seeds can be an amount at least 4 times the weight of the seeds (for example, if the seeds weigh 100 lb, 400 lb of activated charcoal can be adhered to the seeds). In some embodiments, about a 300 lb activated charcoal per acre rate is achieved.

The pelletized coir or seed (which in some examples are at least partially-coated with a binder) can be mixed with a SAP-containing composition to adhere the SAP-containing composition to the seed. Methods that permit such binding are known in the art. For example, the seed can be tumbled (for example in a drum or a roto-stat), and the SAP-containing composition slowly added, for example by applying the SAP-containing composition upon the seeds (such as by spraying). The equipment can be run until the seed is at least partially coated (such as at least 25%, at least 50%, at least 80%, at least 90%, or 100% coated), for example for at least 10 seconds, at least 30 seconds, at least 60 seconds, such as 10 to 90 or 10 to 60 seconds. Similar methods can be used to adhere activated charcoal to seeds.

If desired, the seed or pelletized coir can be colored with an agent (such as a pigment or dye) to identify the coated seed or coated pelletized coir. Ideally, the coloring agent will not significantly inhibit germination or other desirable biological activity of the seed. This colorant can be incorporated into the SAP-containing composition, or into the binder composition. Alternatively, the colorant can be applied after the seed or pelletized coir is coated. An exemplary colorant is aqua-blue. In some examples, if activated charcoal is adhered to the seeds, no additional colorant is added.

If desired, the SAP-containing composition on the seed or pelletized coir can be compacted onto the seed using methods known in the art. Such compacting can be performed to reduce the amount of coating ‘flaking off, for example during transit or handling of the seed or pelletized coir. For example, the coated seed or pelletized coir can be fed into a mechanism, such as an inclined drum or roto-stat, to compact the coating. After the seed it attached to the pelletized coir the composition can be dried. For example, drying can significantly reduce imbibing of moisture by the seed, thereby reducing unwanted pre-germination. In addition, drying can rapidly draw-off moisture without using excessive heat (which can kill the seed). Methods of drying and drying equipment are known in the art, for example using ambient air, a large fluid bed dryer, forced hot air system, a grain bin, or the like. Depending on the type of drying equipment, temperatures for drying can be as high as 130° F. for a short time or a longer time, as described above. After drying, the composition can be screened for size, and can be bagged. In particular examples, the composition can be screened using t mesh screens. The desired-sized particles can be selected, for example fine particulate can be discarded.

In particular examples, the total time to generated pelletized coir with seeds and charcoal (and optionally SAP) attached is about 10 to 20 minutes.

### Example 1

### Generation of Pelletized Coir Coated with Grass Seeds

This example describes methods used to take coir particles and adhere thereto Zeba® superabsorbent polymer particles and grass seeds. One skilled in the art will recognize that similar methods can be used to adhere any other seed to coated coir.

Coir was densified using the following processes. Blocks of coir 12″ square and 6″ in depth with a weight of approximately 10# each were used. The blocks were ground with a tub grinder and achieve 15-30 lb/bushel density. After pelletizing in a California pellet mill the coir product achieved a 55 lb/bushel density. Pelletized coir at 85% of desired end weight was incubated in a roto-stat at 55 RPM. A binder was added at 15% of desired end weight, such as 15% of the desired end weight of polyvinyl alcohol (PVOH). Binder was incubated with the coir for 10 seconds, or until coir pellets began to soften.

Grass seed was at least partially coated with PVOH (such as Celvol® (Celanese Corporation) or BF17 (Kel Chemical)) to adhere the Zeba® coating to the seed. A rate of 1 to 6 pounds of powder PVOH to 100 pounds of grass seed was used to provide a sufficiently moist surface for the Zeba® to adhere. The powdered PVOH was mixed 1:1 with water, heated to 180° F. to dissolve the PVOH, and allowed to cool to 70° F. The raw seed was exposed to the PVOH binder for 5 to 10 seconds at room temperature to obtain thorough coverage on each seed piece using blending.

After coating the seed with PVOH, the seed was at least partially coated with Zeba®. Zeba® was adhered to the seed via a binder to increase the amount of moisture absorbed into the seed coating layer. With Zeba®, cracking will occur in 2 or 3 days, increasing the opportunities for light and moisture penetration and thereby providing greater chance of germination. Only a relatively small amount of Zeba® is needed to provide these benefits; Zeba® was applied at a rate of 1½% to 3% of the weight of the seed. While the seeds were being tumbled in a roto-stat, the Zeba® was applied to the seeds. The seeds were tumbled with the Zeba® composition for about 5 to 10 minutes. This resulted in a coated seed (though 100% coverage by the Zeba® is not required).

The resulting coir pellets were then placed in a roto-stat where SAP-coated perennial ryegrass seeds were attached at a rate of 30-39 gm of seed to 3 lb. of coir pellets, achieving 3-4 seeds per pellet under the following procedure. After allowing the binder to adhere to the pelletized coir, 15% of desired end weight of SAP-coated grass seed was added at an even rate for 20 seconds. The mixture was run for 20 seconds or until the majority of seed has adhered to the coir pellets. The coir-seed pellet was transferred to a dryer, and agitated regularly to avoid clumping and to avoid over heating of seed. The coir-seed pellet was dried until the product reached about 7.5% moisture.

### Example 2

### Planting and Germination of Coated Coir

This example describes methods used to plant the composition described in Example 1. One skilled in the art will recognize that similar methods can be used to plant and germinate similar compositions with other seeds.

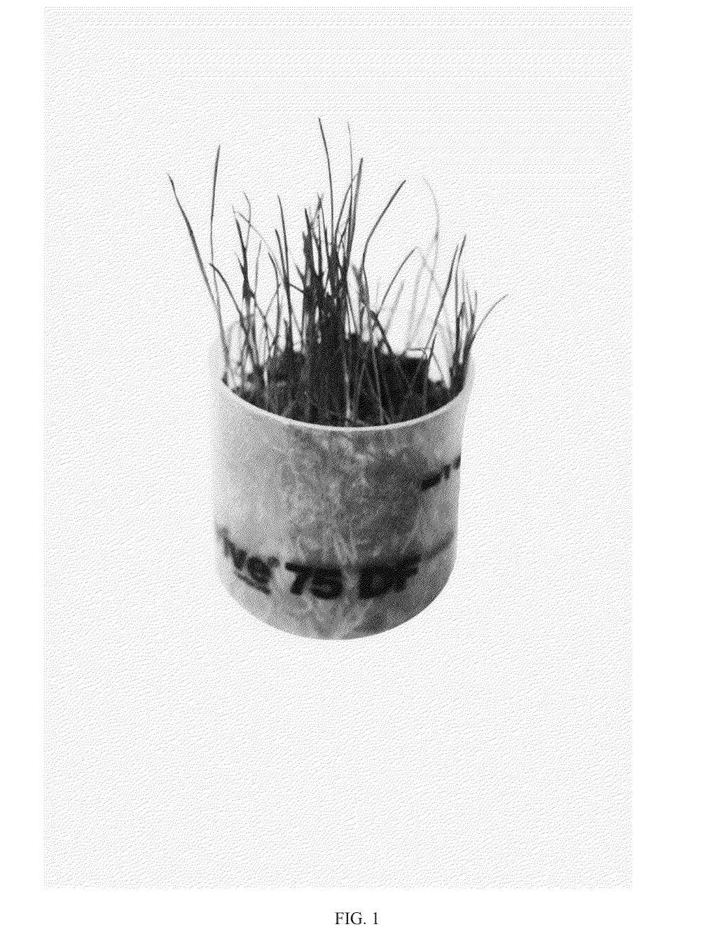

The coir-seed pellets generated in Example 1 were planted in soil and grown indoors with only moderate water. As shown in FIG. 1, the disclosed compositions provide an excellent environment for germination and establishment under dry conditions.

### Example 3

### Planting and Germination of Coated Coir in Northern Canada

This example describes methods used to plant and germinate pelletized coir coated with grass seeds in the snow. One skilled in the art will recognize that similar methods can be used to plant and germinate similar compositions with other seeds, such as canola.

The coir-seed pellets were generated as described in experiment fourteen in Example 4. The coir included 3-5 perennial ryegrass seeds per pellet coated with charcoal. The pellets did not include a SAP. The pellet absorbs and retains large amounts of water, and the charcoal protects the seeds of germinating plants from chemicals used for weed control (e.g., glysophate).

In northern Canada, there is often difficulty achieving germination and establishment of forage and grass seeds. The perennial ryegrass-coated coir were planted in northern Alberta, Canada, on 1 foot centers. These pellets were planted into snow in the winter, in mud conditions, and on dry soil.

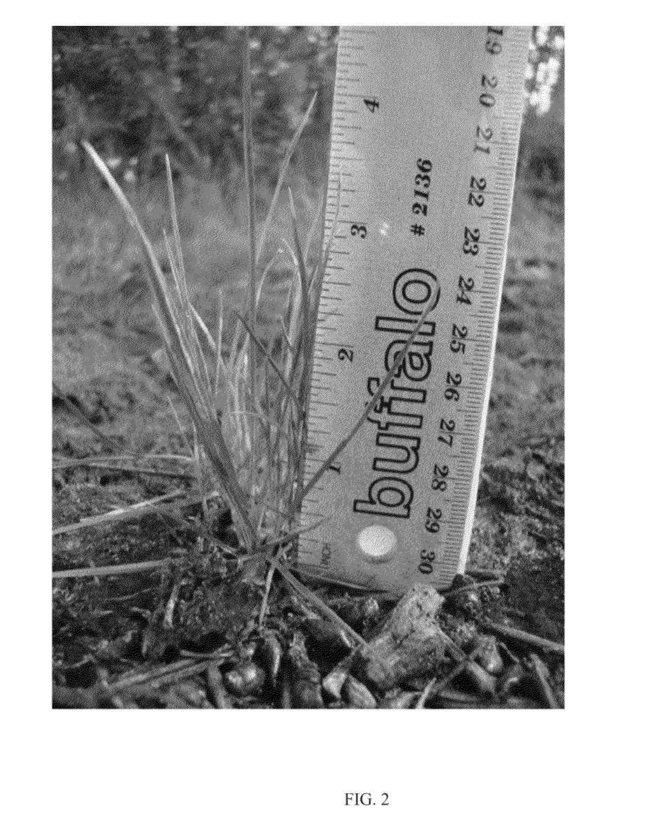

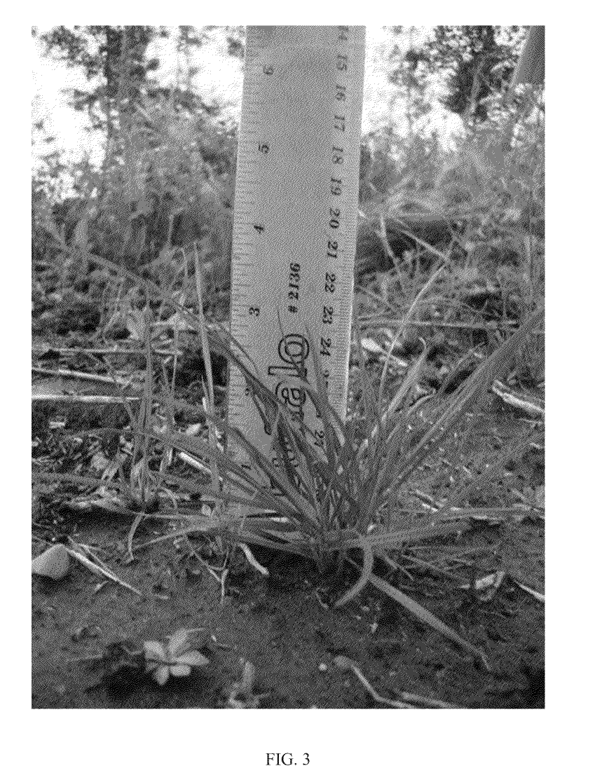

In all cases germination and establishment has been exceptional and far superior to seed planted alone. As shown in FIG. 2, 14 weeks after planting in snow, it was observed that the pellets produced a perfect stand of grass with no tillage and with early establishment. As shown in FIG. 3, similar results were achieved for pellets placed on a dry surface and left to germinate. Thus, the disclosed compositions enhance both germination and establishment.

Based on these results, it is expected that the use of the seed-coated coir will eliminate the need for tillage prior to planting, thereby reducing erosion and soil degradation. It is also expected that planting during out of season conditions, such as snow cover and extremely high moisture situations, will now be possible, resulting in early harvest time (which is the difference between losing and saving a crop).

### Example 4

### Optimizing Coating Conditions

This example describes experiments used to optimize the coating conditions.

Bermuda grass seed (1.8 million seeds/lb or 3965 seeds/gram) can be applied to coir pellets (in some examples each pellet is about 0.454 grams) at a rate of about 3 seeds per pellet (220 pellets+660 seeds). Charcoal can be applied at a rate of 0.0218 grams of charcoal/pellet. This value is based on the rate of 300 lbs of charcoal per solid acre, typically used for grass fields. Zeba® is applied at 1.5-2.0% of pellet weight (0.4157 grams of Zeba®/pellet). Based on these calculations, 400 grams of pellets are contacted with 0.7279 grams Bermuda grass seed, 20.98 grams charcoal, in the presence or absence of Zeba® (if applied, 6 grams of Zeba® is used). This resulted in a final product of 400 grams pellets, 0.7279 grams seed, 20.98 grams charcoal and 6 grams of Zeba®.

In a first experiment, an adhesive was added (polyvinyl alcohol (PVOH)) at a charcoal:adhesive ratio of 3:1. 200 grams pellets were added to a roto-stat and spun at 15 rpm, diflectors at 3. 5.5 ml of 8% PVOH was injected (PVOH dissolved in water), and then immediately 15.5 grams fine powered charcoal added. This resulted in coated pellets, but not all of the charcoal stuck to the pellet (5.2 g of charcoal remained after screening off the coated pellets).

In a second experiment, twice as much adhesive was used. 200 grams pellets were added to a roto-stat and spun at 15 rpm, diflectors at 3. 11 ml of 8% PVOH was injected, and then immediately 15.5 grams fine powered charcoal added. This resulted in coated pellets, but not all of the charcoal stuck to the pellet as before (5.2 g fine dust charcoal (<1.44 mm) and 2.9 g of small charcoal granules (obtained with No. 8 screen)).

In a third experiment, the adhesive was added in two steps. 200 grams pellets were added to a roto-stat and spun at 15 rpm, deflectors at 3. 3.5 ml of 8% PVOH was injected, and then immediately 15.5 grams fine powered charcoal added, followed by 9.5 ml 8% PVOH. This resulted in charcoal not sticking to the pellet (20.6 g fine dust charcoal (<1.44 mm) and 2 g of small charcoal granules (>1.44 mm with No. 8 screen) remained).

In a fourth experiment, 200 grams pellets were added to a roto-stat and spun at 15 rpm, deflectors at 3. 3 ml of 8% PVOH was injected, and then immediately 15.5 grams fine powered charcoal added, followed by 5 ml 8% PVOH. This resulted in charcoal not sticking to the pellet (11.6 g fine dust charcoal (<1.44 mm) and 1 g of small charcoal granules (>1.44 mm with No. 8 screen) remained).

In a fifth experiment, the amount of charcoal was altered to 20.98 g charcoal/400 g pellets, so that on 200 g pellets, 10.49 g charcoal was used instead of 15.5 g charcoal. Zeba® and charcoal were pre-mixed, and then the PVOH added. The pellets used in experiment five were larger than experiments 1-4 (500 pellets/lb). 10.5 g charcoal was mixed with 3 g of Zeba®. 200 g of pellets were added to a roto-stat and spun at 15 rpm, deflectors at 3. 5.5 ml of 8% PVOH was injected, and then immediately the charcoal/Zeba® dry mix added. This resulted in charcoal not sticking to the pellet (12.2 g fine dust charcoal (<1.44 mm) and 0.7 g of small charcoal granules (>1.44 mm with No. 8 screen) remained).

In a sixth experiment, the adhesive was increased to 8 mls, and the charcoal and Zeba® added sequentially (no pre-mixing). 200 g of pellets (size of 500/lb) were added to a roto-stat and spun at 15 rpm, deflectors at 3. 8 ml of 8% PVOH was injected, and then immediately 10.5 g charcoal followed by 3 g Zeba® added. This resulted in a better result than the fifth experiment, but not as good as the first (which had no Zeba®). 11.6 g fine dust charcoal (<1.44 mm) and 1.5 g of small charcoal granules (>1.44 mm with No. 8 screen) remained.

In a seventh experiment, seed was included. 200 g of pellets (size of 500/lb) were added to a roto-stat and spun at 15 rpm, deflectors at 3. 8 ml of 8% PVOH was injected, and then immediately 0.364 g of Bermuda grass seed (R6WL) was added, followed by 10.5 g charcoal followed by 3 g Zeba®. This resulted in good coating of the pellets, but charcoal dust remained (6.5 g fine dust charcoal (<1.44 mm) and 0.8 g of small charcoal granules (>1.44 mm with No. 8 screen) remained.

In a eighth experiment, more adhesive was included. 200 g of pellets (size of 500/lb) were added to a roto-stat and spun at 15 rpm, deflectors at 3. 8 ml of 8% PVOH was injected, and then immediately 0.364 g of Bermuda grass seed (R6WL), followed by 10.5 g charcoal, followed by 3 ml 8% PVOH, followed by 3 g Zeba®, were added. This resulted in good coating of the pellets. 10.6 g fine dust charcoal (<1.44 mm) and 1.3 g of small charcoal granules (>1.44 mm with No. 8 screen) remained.

In a ninth experiment, a different Bermuda grass seed was used. 200 g of pellets (size of 500/lb) were added to a roto-stat and spun at 15 rpm, deflectors at 3. 8 ml of 8% PVOH was injected, and then immediately 0.364 g of Bermuda grass seed (R65B), followed by 10.5 g charcoal, followed by 3 ml 8% PVOH, followed by 3 g Zeba®, were added. This resulted in good coating of the pellets, with only a small amount of charcoal dust and aggregates remaining (3.4 g fine dust charcoal (<1.44 mm) and 2.7 g of small charcoal granules (>1.44 mm with No. 8 screen) remained).

In a tenth experiment, a different Bermuda grass seed and larger pellets were used. 200 g of pellets (size of 500/lb) were added to a roto-stat and spun at 15 rpm, deflectors at 3. 8 ml of 8% PVOH was injected, and then immediately 0.364 g of Bermuda grass seed (R6P0), followed by 10.5 g charcoal, followed by 3 ml 8% PVOH, followed by 3 g Zeba®, were added. This resulted in good coating of the pellets, but not as good as the ninth experiment, with only a small amount of charcoal dust and aggregates remaining (4.6 g fine dust charcoal (<1.44 mm) and 6.4 g of small charcoal granules (>1.44 mm with No. 8 screen) remained).

In an eleventh experiment, smooth Brome grass seeds (usually planted at 113,000 seeds/ft) were used. 300 g of pellets (size of 500/lb) were added to a roto-stat and spun at 15 rpm, deflectors at 3. 12 ml of 8% PVOH was injected, and then immediately 4 g of smooth Brome grass seed (to achieve 3 seeds per pellet), followed by 15.75 g charcoal, followed by 4.5 ml 8% PVOH, followed by 4.5 g Zeba®, were added. This resulted in poor coating of the pellets. Not many seeds stuck to the pellets and there was much charcoal dust. But coverage with charcoal fairly good (better than trial 10, but not as good as trial 9). 10.1 g fine dust charcoal (<1.44 mm) and 5.6 g of small charcoal granules (>1.44 mm with No. 8 screen) remained).

In a twelfth experiment, only smooth Brome grass seeds and large pellets were used, to determine how much seed will stick onto the large pellets. 300 g of pellets (size of 500/lb) were added to a roto-stat. 5 ml of 8% PVOH was injected, and then immediately 6.32 g of smooth Brome grass seed (to achieve 5 seeds per pellet), followed by 19 ml 8% PVOH. This resulted in about 70% of the pellets having 1-3 seeds, and about 50% of the seeds stuck to the pellets.

In a thirteenth experiment, charcoal was added to the conditions described for the 12^{th} experiment. 300 g of pellets (size of 500/lb) were added to a roto-stat. 5 ml of 8% PVOH was injected, and then immediately 6.32 g of smooth Brome grass seed (to achieve 5 seeds per pellet), followed by 19 ml 8% PVOH, and 6.15 g of charcoal (for 0.0218 g charcoal per pellet). This resulted in poor coating. There were many seed/charcoal clumps, with few seeds on the pellets.

In a fourteenth experiment, conditions similar to the 9^{th} and 10^{th} experiments were used. 300 g of large pellets were added to a roto-stat and spun at 15 rpm, deflectors at 3. 12 ml of 8% PVOH was injected, and then immediately 6.32 g of Brome grass seed was added, followed by 6.15 g charcoal, followed by 4.5 ml 8% PVOH, followed by 4.5 g Zeba®. This resulted in good coating of the pellets and good seed attachment. Very little seed was left in the coater.

### Example 5

### Methods of Making Planting Compositions Comprising Ground Coir

This example describes the use of ground coir in planting compositions.

Coir, whether in natural form (for example as coir dust or fibers) or pelletized, can be ground to a desired size and used as a planting composition. For example, the ground coir can be generated from blocks of coir. Blocks of coir 12″ square and 6″ in depth with a weight of approximately 10# each are used. The blocks are ground with a tub grinder to achieve 15-30 lb/bushel density. The ground coir is pelletized in a California pellet mill. The pelletized coir product can achieve a 45 lb/bushel density.

The ground coir is passed through a screen to separate coir of fine, medium, or coarse grade. In some embodiments, the desired size of the ground coir particles is the size of the seed with which the ground coir will be mixed. For example, if the seed is ryegrass, a screen of 7/64″ can be used. The planting mix with ground coir is applied to the planting area, for example using a spreader to achieve about a ⅛ inch thick layer. Seeds are included in the ground coir planting composition either before or after the planting composition is applied to the planting area. When water is absorbed by the coir, the layer swells to ¼ inch thick and creates an environment conducive to germination of the seed.

Pelletized coir can be ground. Ground coir (such as medium grade ground coir) is then mixed with pelletized coir in a 1:1 ratio to achieve 45 lb/bushel density. The pelletized coir/ground coir mixture can be mixed with seed, or the pelletized coir can have seed adhered to the surface of the pellet. The pelletized coir/ground coir mixture is then spread with a spreader over a desired planting area. The mixture can also include activated charcoal mixed with the ground coir or attached to the pelletized coir, for example attached thereto with polyvinyl alcohol (PVOH) or another binder or glue that does not substantially inhibit seed germination and aids in the establishment of plants in dry conditions.

The use of an organic material such as coir holds moisture, which is made available to the seed during germination, for example in climates that are dry, and a more favorable condition for germination and/or establishment is achieved.

### Example 6

### Methods of Generating Seed-Encased Dough Pellets

This example describes methods used to pelletize planting mix compositions which include seeds, without damaging the seed.

Coir was densified using the following processes. Blocks of coir 12″ square and 6″ in depth with a weight of approximately 10# each were used. The blocks were ground with a tub grinder to achieve 12-14 lb/bushel density. After pelletizing in a California pellet mill the coir product achieved a 40-60 lb/bushel density. The pelletized coir was reground and mixed with cornmeal or corn flour, charcoal, fungicide, seed, or any combination thereof, to make a dough. Exemplary doughs include 40% corn flour, 50% fine coir, 2.5% SAP, 2.5% charcoal, 2.5% seed, and 2.5% fungicide (w/w); 40% corn flour, 52.5% fine coir, 2.5% SAP, 2.5% seed, and 2.5% fungicide (w/w); 50% corn flour, 33% medium coir, 1% SAP, 11% charcoal, 2.5% seed, and 2.5% fungicide (w/w); 33% coir, 60% cornmeal or corn flour, 2% SAP, 2.5% charcoal, 2.5% seed (w/w); 40% corn flour, 55% fine coir, 2.5% SAP, and 2.5% seed (w/w); 40% corn flour; 52.5% fine coir, 2.5% SAP, 2.5% charcoal, 2.5% seed (w/w); 40% corn flour, 40% coir, 2.5% SAP (for example Zeba®), 10% compost, 2.5% charcoal, 2.5% fungicide (for example, Captan), and 2.5% seed; or 40% corn flour, 42.5% coir, 2.5% SAP (for example Zeba®), 10% compost, 2.5% charcoal, and 2.5% seed.

The dough is thoroughly mixed and extruded through a die producing ¼ inch or ⅜ inch diameter strands, cut into pellets of approximately ½ inch lengths. The pellets are then dried. A 240 Oliver drier plus a BM & M screen machine are used to cool and screen the pellets. These pellets have the seed encased, are very durable, and have a density of 40-45 lb/bushel.

### Example 7

### Planting and Germination of Seeds Encased in Pelletized Coir

This example describes methods used to plant the composition described in Example 6 including canola seed. One skilled in the art will recognize that similar methods can be used to plant and germinate similar compositions with other seeds.

Individual pellets (40% corn flour, 52.5% fine coir, 2.5% Zeba®, 2.5% Captan, and 2.5% Bayer canola seed) containing, on average, 3 seeds per pellet, were planted one foot apart (1 pellet/square foot). Canola started to germinate in 5 days and 90% of the pellets germinated within 7 days.

Based on these results, it is expected that the use of the pelletized coir with encased seeds will eliminate the need for tillage prior to planting, thereby reducing erosion and soil degradation. It is also expected that planting during out-of-season conditions, such as snow cover and extremely high moisture situations, or following fire damage, or following (or during) drought conditions, will now be possible, resulting in early harvest time (which is the difference between losing and saving a crop).

### Example 8

### Germination of Seeds Encased in Pelletized Coir

This example describes methods used to germinate canola seeds in the composition described in Example 6. One skilled in the art will recognize that similar methods can be used to germinate (and subsequently plant) similar compositions with other seed types.

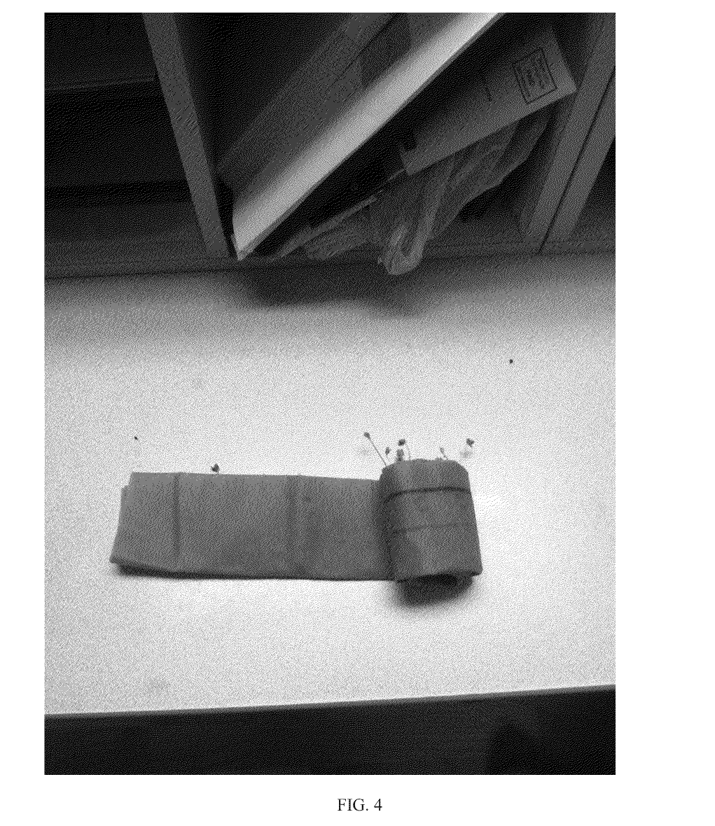

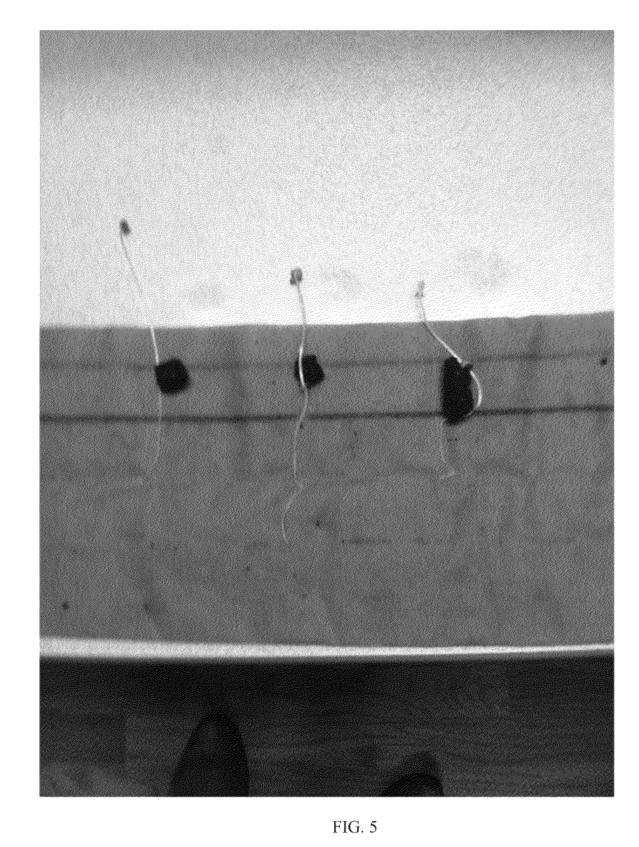

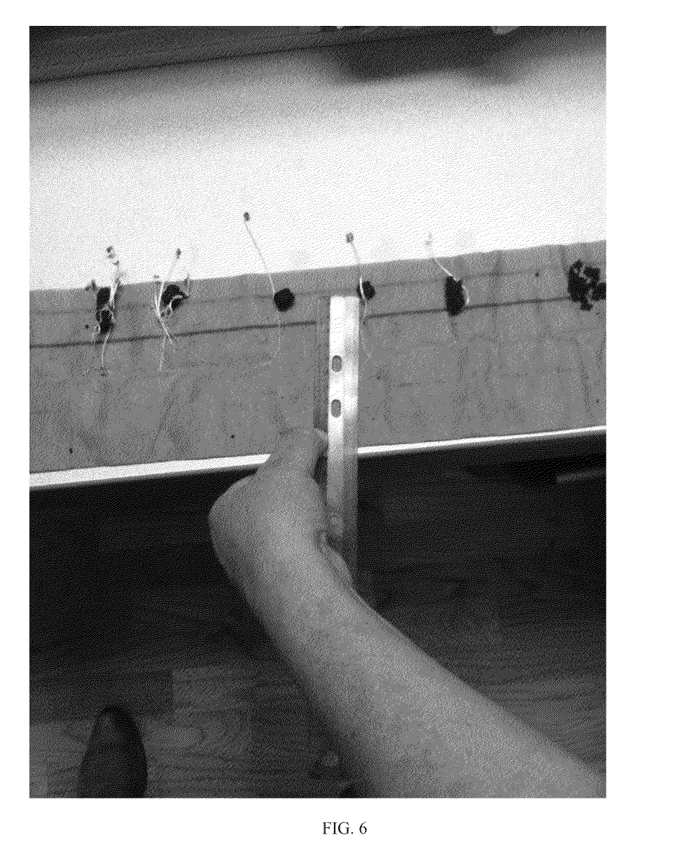

Individual pellets (40% corn flour, 42.5% coir, 2.5% Zeba®, 10% compost, 2.5% charcoal, and 2.5% canola seed) containing, on average, 3 seeds per pellet, were rolled in a paper towel marked at one inch intervals and the rolled paper towel containing the pellets were put in a tray with water. Water was allowed to wick up into the paper. The moistened paper towel rolls including the pellets were incubated in the water tray in a grain germinator at 20° C. during the night and 30° C. during the day and were monitored for germination/sprouting. Canola started to germinate in 5 days and 90-100% of the pellets germinated within 10 days. At six days, canola roots measured, in some cases, approximately 2.5 inches (or approximately 6 cm) in length (FIGS. 4-6).

Based on these results, it is expected that the use of the pelletized coir with encased seeds will eliminate the need for tillage prior to planting, thereby reducing erosion and soil degradation. It is also expected that planting during out-of-season conditions, such as snow covered and extremely high moisture situations, or following fire damage, or following (or during) drought conditions, will now be possible, resulting in early harvest time (which is the difference between losing and saving a crop).

### Example 9

### Planting and Germination of Seed-Encased Dough Pellets in Northern Canada

This example describes methods used to plant and germinate ryegrass seeds encased in dough pellets (for example in the spring). One skilled in the art will recognize that similar methods can be used to plant and germinate similar compositions with other seeds, such as canola (see Example 10).

In northern Canada, because of the long winters, it is often difficult to achieve germination of seeds and/or establishment of seedlings early enough in the year to obtain a harvest before cold weather damages the crops. Traditionally, planting of seeds does not begin until after the snow has melted so that the seeds can be tilled directly in the soil. Accordingly, waiting for the snow to melt in order to plant seeds, such as ryegrass and canola, can significantly delay the time of harvest and risks a poor crop yield. However, the use of ryegrass or canola seed-encased dough pellets does not require that the fields be cleared of snow, or otherwise prepared for planting (such as tilling the soil), because the pellets are broadcast on the surface of the snow. Moreover, as the snow melts in the sun, the seed-encased dough pellets (which are black due to the charcoal in the dough mixture) are warmed by the sun, thereby creating an environment that is conducive to germination of the seeds. Thus, the seeds in the dough pellets germinate before the snow is completely melted and seedlings are established much earlier in the planting season compared to naked seed (seed not encased in a pellet) planted in a tilled field. This method therefore enhances the harvest because the crop can be harvested earlier and the amount of harvest lost due to poor weather is reduced. Alternatively, the pellets can be planted in high moisture conditions (for example, muddy fields) or on dry soil to yield an enhanced harvest.

In this method, ryegrass seed-encased dough pellets were generated as described in Example 6. The composition is shown below:

### CRP Formula

### Grass Seed Square Pellets

| Ingredients | Percentage % | Grams | |
|---|---|---|---|
| 3524 Alfalfa | 0.2 | 5 | |
| 3519 Alfalfa | 0.2 | 5 | |
| Corn Flour | 40 | 908 | |
| Coir | 44 | 955.7 | |
| Zeba | 2.5 | 56.8 | |
| Charcoal | 2 | 56.8 | Optional |
| CRP Grass Blend(Paul Herman) | 2.5 | 56.8 | |
| Compost | 10 | 227 | optional |
| Total | 99.9 | 2271.1 | |

The pellets included approximately three ryegrass seeds per pellet. Each ryegrass seed-encased dough pellet was planted in the center of adjacent 1 foot square areas in a snow-covered field in northern Alberta, Canada in the Spring/Summer of 2013, which experienced a drought and was replanted in late Spring and allowed to germinate.

In all cases germination and establishment was exceptional and far superior to results seen previously when seed is planted alone. The pellets placed on snow produced a perfect stand of ryegrass with no tillage and with plants established about 30 days earlier than would have been seen if naked seed was used. Thus, the disclosed compositions enhance both germination and establishment of the ryegrass (or canola, see Example 10).

It was observed that round pellets have a minimum area that comes in contact with the soil. When tested in temperatures of 70° to 80° F. and dehydrating winds as high as 35 knots per hour, the round pellets dried and establishment was poor. To solve this problem, square pellets of 7/16″ and ½″ were generated and tested. These pellets are similar to dice in configuration. It was observed that square pellets had better soil contact and enabled improved contact with the soil thereby reducing the damage of temperature and high winds. Plantings in the spring of 2013 lead to a 100% success with CRP mix in the table above (and canola).

It is expected that planting during out of season conditions, such as in snow covered and extremely high moisture situations, will now be possible with the seed-encased dough pellets. It is also expected that the use of the seed-encased dough pellets will eliminate the need for tillage prior to planting, thereby reducing erosion and soil degradation, and allowing for earlier planting and harvest.

### Example 10

### Planting and Germination of Canola Seed-Encased Dough Pellets in Northern Canada

This example describes methods used to plant and germinate canola seeds encased in dough pellets, for example on fields covered in snow.

Canola seed-encased dough pellets were generated as described in Example 6. The pellets included approximately three canola seeds per pellet. Pellets were 7/16″ or ½″ cubes. The formula for the pellets is shown below

### Canola Pellet Formula

| | | 1 Pound |
|---|---|---|
| | | Batch |
| | Percentage | Grams |
| Coir | 45.00% | 204.3 |
| Corn Meal | 42.50% | 192.95 |
| Lime | 5.00% | 22.7 |
| Charcoal | 2.50% | 11.35 |
| Zeba | 2.50% | 11.35 |
| Canola Bayer Seed | 2.50% | 11.35 |
| | 100.00% | 454 |

Each pellet was planted using a 4′×4′ piece of plywood with holes drilled every square foot in Dawson Creek, North of Edmonton Canada, and allowed to germinate. Do to the spring drought in this area, the trial was replanted after the rains came.

Results similar to those described in Example 9 are expected.

### Example 11

### Testing of Grass-Patch Products

This example describes results showing the superior results achieved using 90% ground coir and 10% grass seed as compared to other grass-patch products available on the market.

A composition containing 90% coir (Nutrifield® Premium Coco Coir, Victoria, Australia) and 10% grass seed were generated. Briefly, the coir was pelletized and ground with a density of 45-46 lbs/per cubic foot.

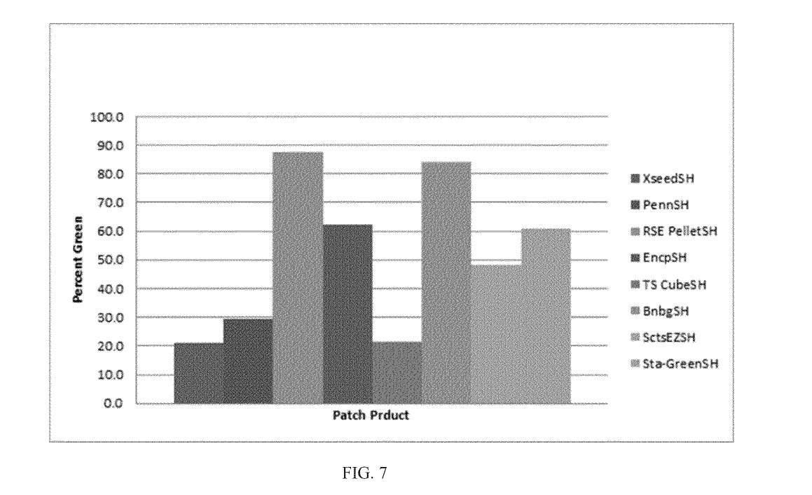

As shown in FIG. 7, a composition containing 90% coir and 10% seed (RSE Pellet SH) showed a higher percentage of greening than the other products tested.

In view of the many possible embodiments to which the principles of the disclosure may be applied, it should be recognized that the illustrated embodiments are only examples of the disclosure and should not be taken as limiting the scope of the disclosure. Rather, the scope of the disclosure is defined by the following claims. I therefore claim as my invention all that comes within the scope and spirit of these claims.

I claim:

1. A composition, comprising:
coir, corn flour, and seed, formed into a pellet.

2. The composition of claim 1, further comprising activated charcoal.

3. The composition of claim 1, further comprising a super-absorbent polymer (SAP).

4. The composition of claim 1, further comprising a fungicide, lime, compost, or combinations thereof.

5. The composition of claim 1, wherein the composition is a 7/16″ or ½″ cube.

6. The composition of claim 1, wherein the cornmeal or corn flour comprises about 30%-60% of the weight of the pellet.

7. The composition of claim 1, wherein the coir comprises about 30%-50% of the weight of the pellet.

8. The composition of claim 2, wherein the charcoal comprises about 1%-12% of the weight of the pellet.

9. The composition of claim 1, wherein the seed comprises about 2%-3% of the weight of the pellet.

10. The composition of claim 3, wherein the SAP comprises about 1.0-3.0% of the weight of the pellet.

11. The composition of claim 4, wherein the fungicide comprises about 1.0%-3.0% of the weight of the pellet.

12. The composition of claim 5, wherein the compost comprises about 5%-20% of the weight of the pellet.

13. The composition of claim 3, comprising 40% corn flour; 55% coir, 2.5% Zeba®, and 2.5% seed.

14. The composition of claim 9, wherein the seed comprises grass seed, flower seed, vegetable seed, or crop seed.

15. The composition of claim 1, wherein the pellets have increased germination relative to seed alone or seed attached to a surface of a pellet.

16. The composition of claim 1, wherein the pellet is about ⅜ inch in diameter and about 1 inch in length.

17. A method of making a pelletized planting mix composition, comprising:
mixing coir, cornmeal or corn flour, and seed to form a dough or compost; and
passing the dough through an extruder to form pellets.

18. The method of claim 17, further comprising adding one or more of activated charcoal, a SAP, a fungicide, or compost to the mixture that forms the dough.

19. The method of claim 17, further comprising cutting and drying the dough.
